(19) United States
(12) Patent Application Publication
(10) Pub. No.: US 2024/0370949 A1
(43) Pub. Date: Nov. 7, 2024

(54) SYSTEMS AND METHODS FOR DETECTING ANOMALOUS WATER USAGE

(71) Applicant: STATE FARM MUTUAL AUTOMOBILE INSURANCE COMPANY, Bloomington, IL (US)

(72) Inventors: Julie K. Fritz, Gilbert, AZ (US); Alexander Cardona, Gilbert, AZ (US); Olivia Nauman, Phoenix, AZ (US); Diana Sherwood, Scottsdale, AZ (US); Brian Fields, Phoenix, AZ (US)

(21) Appl. No.: 18/330,182

(22) Filed: Jun. 6, 2023

Related U.S. Application Data
(60) Provisional application No. 63/463,961, filed on May 4, 2023.

(51) Int. Cl. G06Q 50/06; G06N 5/025; G06Q 50/16

(52) U.S. Cl. CPC G06Q 50/06; G06N 5/025; G06Q 50/163

(57) ABSTRACT

System and methods for detecting anomalous water usage at a property having a water supply system using machine learning (ML) are provided. An ML model may generate an estimated water usage of the property associated with the property data set, where the property data set may include attributes of the property influencing the water usage of the property. The ML model may be configured to learn relationships between a historical water usage data set and a historical property data set. The systems and methods may compare the water usage of the property and the estimated water usage of the property. If the comparison indicates the water usage exceeds a threshold, a notification may be generated and provided to a user device.

### CROSS-REFERENCE TO RELATED APPLICATIONS

This application claims priority to and the benefit of the filing date of provisional U.S. Patent Application No. 63/463,961 entitled “SYSTEMS AND METHODS FOR DETECTING ANOMALOUS WATER USAGE,” filed on May 4, 2023, the entire contents of which is hereby expressly incorporated herein by reference.

### FIELD OF THE INVENTION

The present disclosure generally relates to detecting water usage, and more particularly, detecting anomalous water usage at a property having a water supply system using machine learning.

### BACKGROUND

A water supplier may provide a customer with an indication of the amount of water being used at a property, such as a monthly report indicating the number of gallons used during the month. However, this otherwise valuable information may appear abstract and/or be of little use to the customer without proper context.

For example, without knowing what water usage for a property having similar attributes may be, the customer may not have a sense of whether their water usage is conservative, average, or excessive. Without such insight, the customer may not be motivated to alter water usage they may find extreme or undesirable. Moreover, the customer may be consigned to simply trust that their water supplier's equipment is accurately measuring and/or reporting their actual usage if they do not have a way to verify their actual water usage directly or have a sense of what may be considered average water usage for similar households and/or properties in their community.

Beyond water usage habits of a household, the water usage information may also indicate an unknown problem at the home, such as a leak (e.g,. irrigation system) or a running water supply which may not have been properly turned off (e.g., faucet, hose), among other things. Were the customer made aware of excessive and/or inconsistent water usage at their property, it may prompt the customer to investigate their property for a leak or other anomaly, potentially saving them time, money and/or hardship.

The conventional water usage monitoring techniques may include additional ineffectiveness, inefficiencies, encumbrances, and/or other drawbacks.

### SUMMARY

The present embodiments may relate to, inter alia, systems and methods for detecting anomalous water usage at a property having a water supply system using machine learning (ML). The systems and methods may provide water usage information to a property owner, which may provide context for the water usage of the property, e.g., whether the water usage is conservative, average, or excessive. In one example, the property owner may gain insight into how water usage of the property compares to historical water usage of the property, water usage of other properties having similar attributes, such as similarly sized properties in their community or properties with similar households, among other things. The water usage information may also be an indicator of a leak or other unexpected water usage when detecting anomalous water usage of the property, such as for an appliance, a water line, and/or the property in general. In addition to water usage information, the systems and methods may also provide valuable actionable information to a property owner, such as recommendations to change water usage habits.

In one aspect, a computer-implemented method for detecting anomalous water usage at a property having a water supply system using ML may be provided. The computer-implemented method may be implemented via one or more local or remote processors, servers, personal computers, Internet-of-things (IoT) devices, transceivers, sensors, memory units, mobile devices, wearables, smart watches, smart contact lenses, smart glasses, augmented reality glasses, virtual reality headsets, mixed or extended reality glasses or headsets, voice bots or chatbots, ChatGPT bots, and/or other electronic or electrical components, which may be in wired or wireless communication with one another. In one instance, such computer-implemented method may include, via one or more processors and other devices: (1) obtaining a property data set of the property, wherein the property data set includes attributes of the property influencing the water usage of the property; (2) providing the property data set to an ML model trained to generate an estimated water usage of the property associated with the property data set, wherein: (a) the ML model is trained using a historical training data set; (b) the historical training data set includes, for a plurality of properties: (i) a historical water usage data set indicating historical water usage of the plurality of properties; and/or (ii) a historical property data set including attributes of the plurality of properties influencing the water usage of the plurality of properties; and/or (c) the trained ML model is configured to learn relationships between the historical water usage data set and the historical property data set; (3) obtaining a water usage data set of the property indicating water usage of the property; (4) comparing the water usage and the estimated water usage of the property; (5) responsive to comparing the water usage and the estimated water usage of the property, generating a notification based upon the water usage and the estimated water usage comparison exceeding a threshold; and/or (6) providing the notification to a user device. The method may include additional, less, or alternate functionality or actions, including those discussed elsewhere herein.

In another aspect, a computer system for detecting anomalous water usage at a property having a water supply system using ML may be provided. The computer system may include one or more local or remote processors, servers, personal computers, IoT devices, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT bots, and/or other electronic or electrical components, which may be in wired or wireless communication with one another. In one instance, such computer system may include one or more non-transitory memories storing processor-executable instructions that, when executed by the one or more processors, cause the system to: (1) obtain a property data set of the property, wherein the property data set includes attributes of the property influencing the water usage of the property; (2) provide the property data set to an ML model trained to generate an estimated water usage of the property associated with the property data set, wherein: (a) the ML model is trained using a historical training data set; (b) the historical training data set includes, for a plurality of properties: (i) a historical water usage data set indicating historical water usage of the plurality of properties; and/or (ii) a historical property data set including attributes of the plurality of properties influencing the water usage of the plurality of properties; and/or (c) the trained ML model is configured to learn relationships between the historical water usage data set and the historical property data set; (3) obtain a water usage data set of the property indicating water usage of the property; (4) compare the water usage and the estimated water usage of the property; (5) responsive to comparing the water usage and the estimated water usage of the property, generate a notification based upon the water usage and the estimated water usage comparison exceeding a threshold; and/or (6) provide the notification to a user device. The computer system may include additional, less, or alternate functionality, including that discussed elsewhere herein.

In one aspect, a non-transitory computer-readable medium is provided, storing processor-executable instructions that, when executed by one or more processors, cause the one or more processors to: (1) obtain a property data set of the property, wherein the property data set includes attributes of the property influencing the water usage of the property; (2) provide the property data set to an ML model trained to generate an estimated water usage of the property associated with the property data set, wherein: (a) the ML model is trained using a historical training data set; (b) the historical training data set includes, for a plurality of properties: (i) a historical water usage data set indicating historical water usage of the plurality of properties; and/or (ii) a historical property data set including attributes of the plurality of properties influencing the water usage of the plurality of properties; and/or (c) the trained ML model is configured to learn relationships between the historical water usage data set and the historical property data set; (3) obtain a water usage data set of the property indicating water usage of the property; (4) compare the water usage and the estimated water usage of the property; (5) responsive to comparing the water usage and the estimated water usage of the property, generate a notification based upon the water usage and the estimated water usage comparison exceeding a threshold; and/or (6) provide the notification to a user device. The instructions may direct additional, less, or alternate functionality, including that discussed elsewhere herein.

### BRIEF DESCRIPTION OF THE DRAWINGS

The figures described below depict various aspects of the applications, methods, and systems disclosed herein. It should be understood that each figure depicts one embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 depicts a block diagram of an exemplary computer environment in which methods and systems for detecting anomalous water usage at a property are implemented.

FIG. 2 depicts a block diagram of an exemplary mobile device in which computer-implemented methods and systems for detecting anomalous water usage at a property are implemented, according to one embodiment.

FIG. 3 depicts a block diagram of an exemplary augmented reality viewer device in which computer-implemented methods and systems for detecting anomalous water usage at a property are implemented, according to one embodiment.

FIG. 4 depicts a combined block and logic diagram in which exemplary computer-implemented methods and systems for detecting anomalous water usage at a property using machine learning are implemented, according to one embodiment.

FIG. 5 depicts a depicts an exemplary block diagram of a system for detecting anomalous water usage at a property using machine learning, according to one embodiment.

FIG. 6 depicts an exemplary water usage dashboard, according to an embodiment.

FIG. 7 depicts an exemplary augmented reality display providing water usage information, according to an embodiment.

FIG. 8 depicts an exemplary computer-implemented method for detecting anomalous water usage at a property are implemented, according to one embodiment.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

### Overview

The computer systems and methods disclosed herein generally relate to, inter alia, methods and systems for detecting anomalous water usage at a property having a water supply system using machine learning (ML), and/or other processor analysis of a historical training data set.

Some embodiments may use techniques to obtain a property data set of the property, which may include attributes of the property influencing the water usage of the property. The attributes may include one or more of a size of the property, a household size of the property, appliances of the property, climate of the property, and/or water features of the property.

The property data set may be provided to an ML model trained to generate an estimated water usage of the property associated with the property data set. The ML model includes an algorithm including one or more of k-nearest neighbor, support vector regression, and/or random forest. The trained ML model may be configured to learn relationships between the historical water usage data set and the historical property data set.

The historical water usage data set may indicate historical water usage of the plurality of properties. The historical water usage data set may be crowd-sourced by obtaining a plurality of historical water usage data entries corresponding to the plurality of properties from a plurality of data providers respectively associated with a corresponding property of the plurality of properties.

The historical water usage data set may include a historical property data set including attributes of the plurality of properties influencing the water usage of the plurality of properties. Some embodiments may include updating historical training data to include new data indicative of relationships between the historical water usage data set and the historical property data set, retraining the ML model based upon the updated historical training data set and storing the retrained ML model on one or more memories.

Some embodiments may use techniques to obtain a water usage data set of the property indicating water usage of the property. The system and methods may compare the water usage and the estimated water usage of the property and, responsive to comparing the water usage and the estimated water usage of the property, generate a notification based upon the water usage and the estimated water usage comparison exceeding a threshold which may be provided to a user device. In one aspect, obtaining the water usage data set of the property may include detecting, via one or more Internet-of-things (IoT) sensors, water usage data associated with an IoT sensor of the property and receiving via the one or more IoT sensors, the IoT sensor water usage data. In one aspect, obtaining the water usage data set of the property may include obtaining water usage data associated with a water meter of the property.

The notification may include actionable information comprising one or more recommendations of actions to be taken to reduce the water usage of the property based upon the water usage and the estimated water usage comparison. The notification may include one or more of an explanation of the water usage, or an access link to a water usage dashboard.

Some embodiments may use techniques to generate a water usage dashboard including water usage information of the property, provide an access link to the water usage dashboard to the user device, and receive water usage validation at the water usage dashboard via the user device.

As used herein, the term augmented reality (AR) may refer to generating digital content (i.e., an AR display) which is overlaid on a view of the user's physical environment via a display of a viewer device, such as on a transparent surface of a viewer device, such that a wearer/user of the AR viewer device (which may include AR glasses or headsets) is still able to view their physical environment. The AR display may include virtual images, text, models, sounds, animations, videos, instructions, multimedia and/or other digitally-generated content.

As used herein, the term “property owner” indicates any individual or entity associated with the property, such as a person or entity who owns or manages the property, a family member of the person who owns the property, a person renting/subletting the property, a person living or working on the property, or any other individual that may have an interest in fixing damage to the property.

### Exemplary Computer Environment

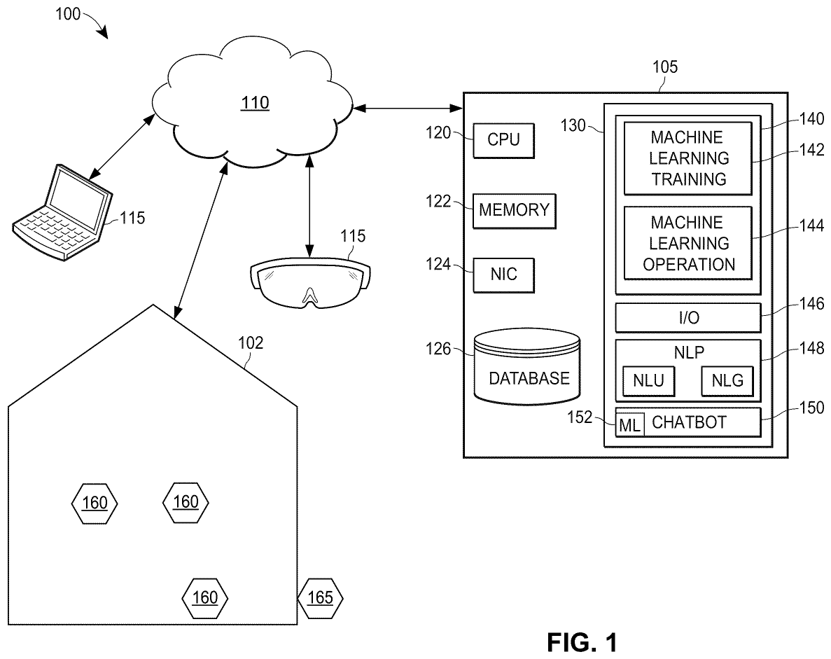

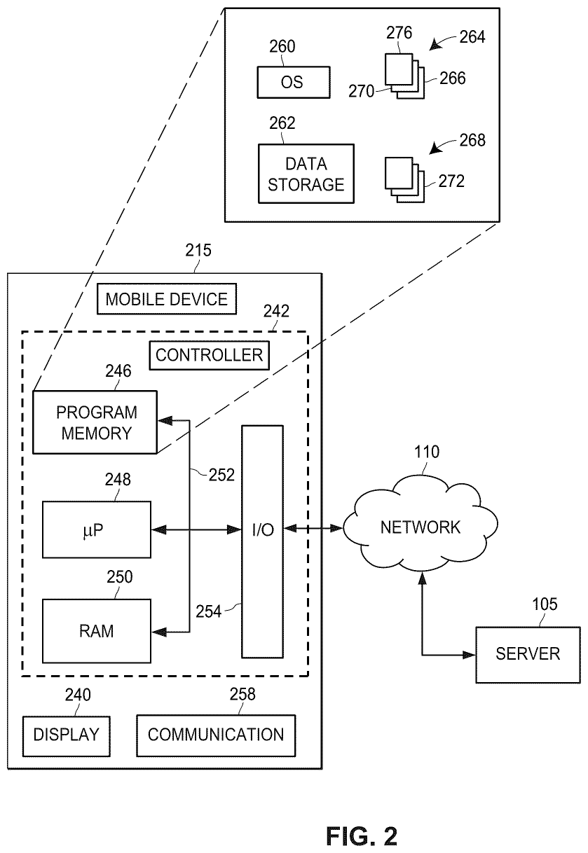

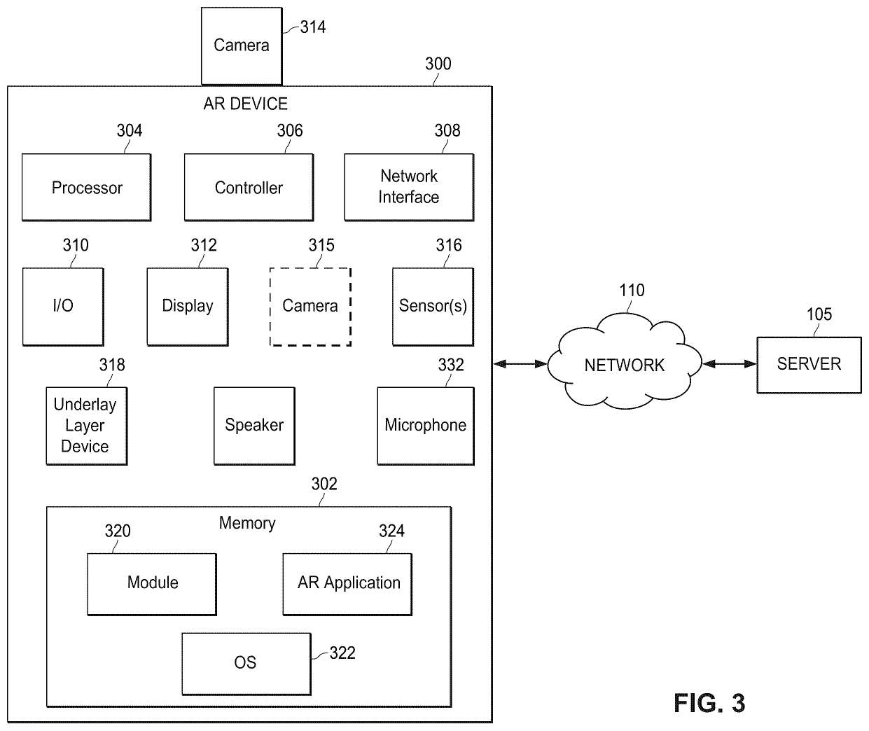

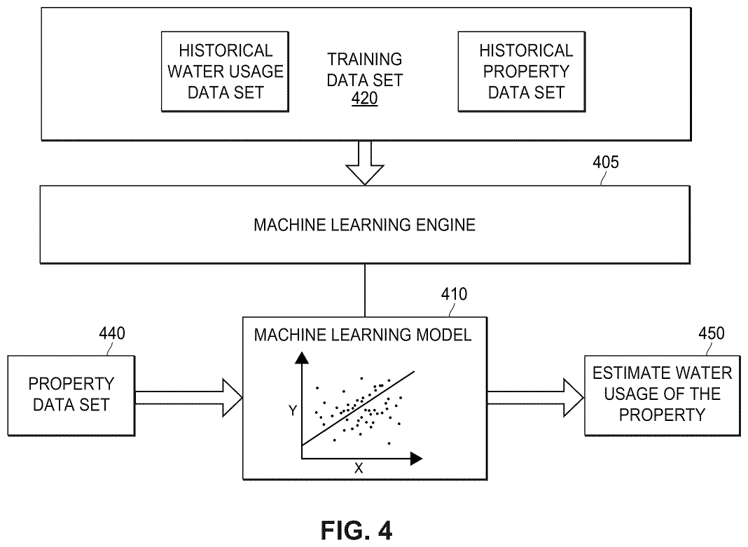

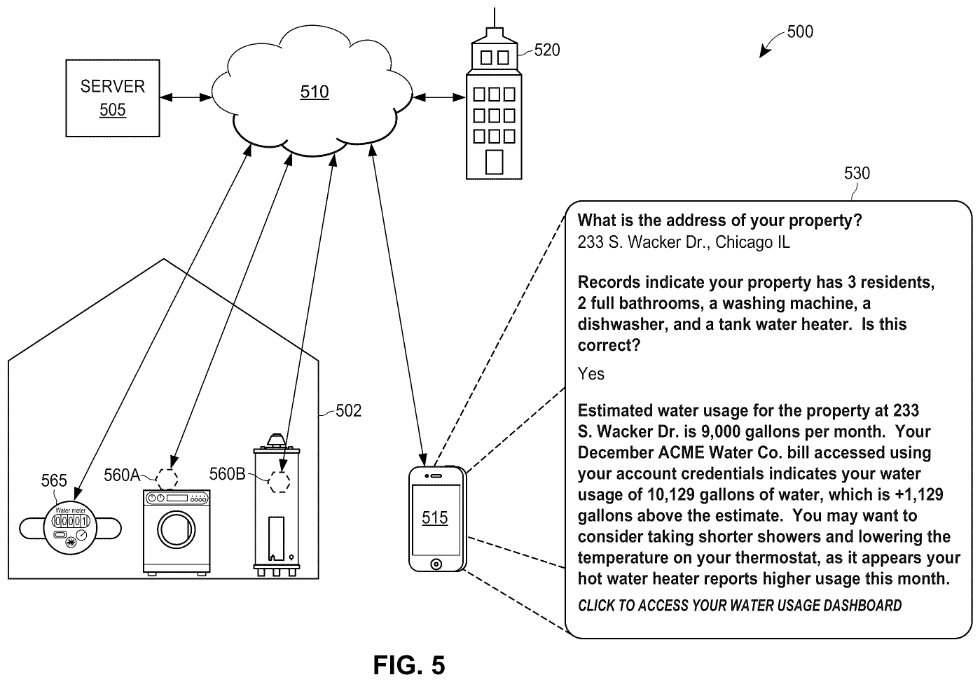

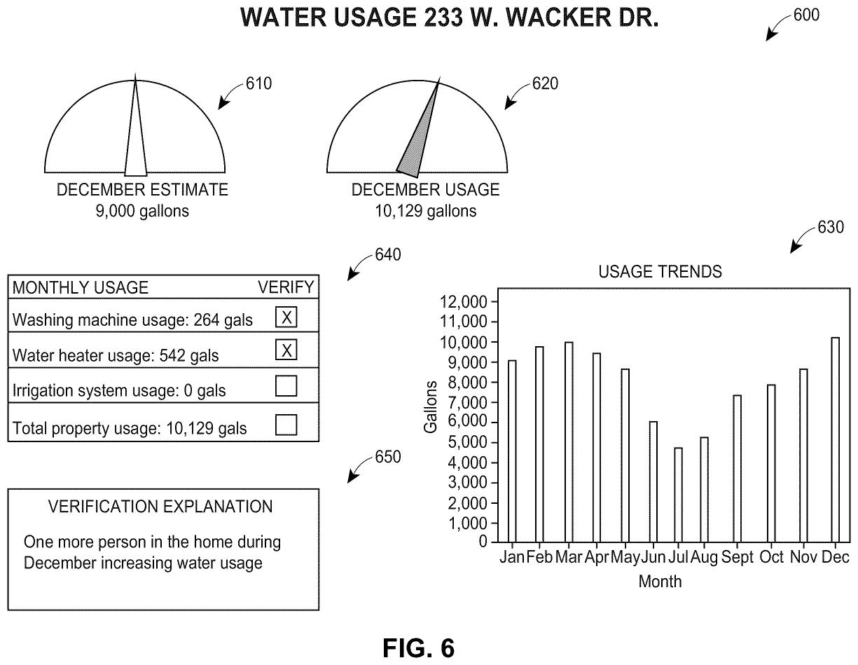

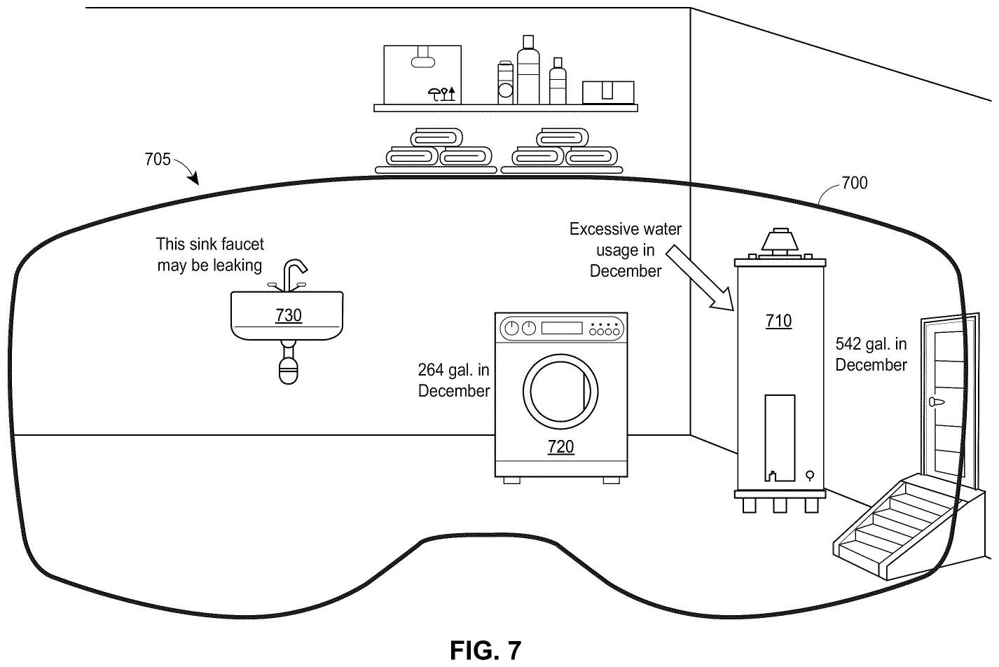

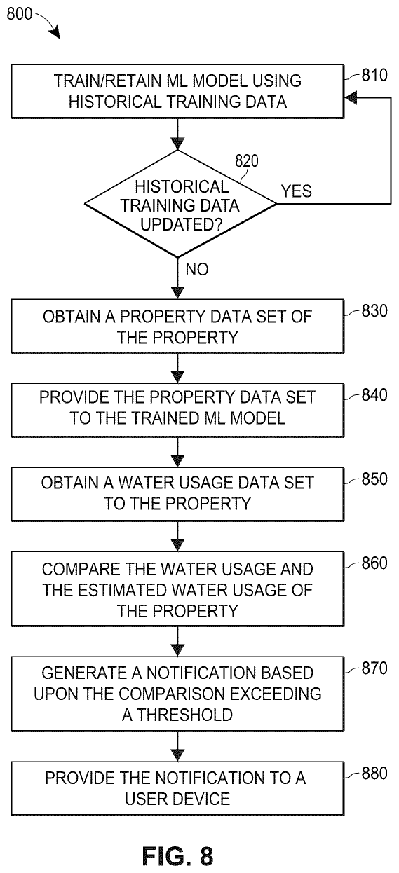

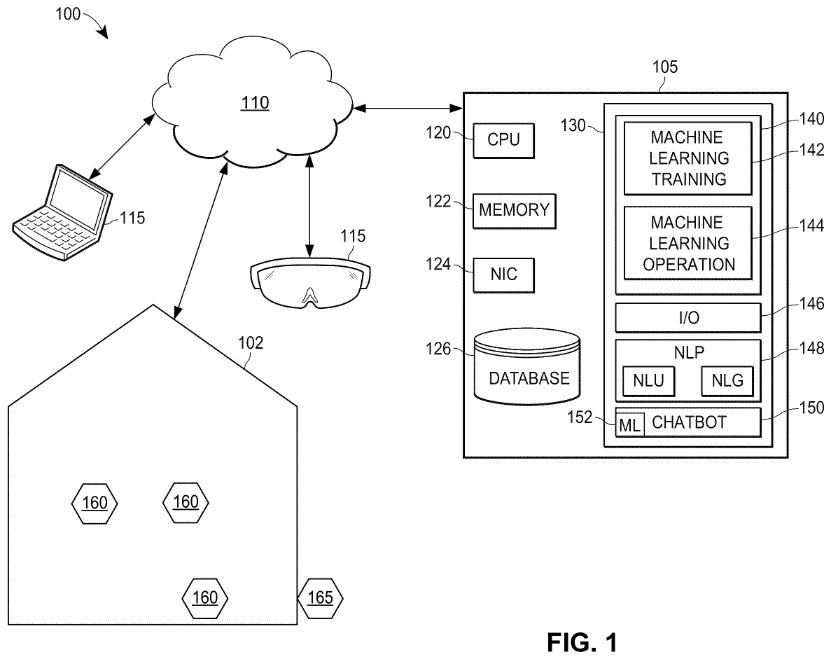

FIG. 1 depicts an exemplary computing environment 100 associated with detecting anomalous water usage at a property, such as a home 102, having a water supply system using ML. Although FIG. 1 depicts certain entities, components, equipment, and devices, it should be appreciated that additional or alternate entities, components, equipment, and devices are envisioned.

As illustrated in FIG. 1, the environment 100 may include in one aspect, one or more servers 105 which may perform the functionalities, such as generating estimated water usage of a property. The server 105 may be part of a cloud network or may otherwise communicate with other hardware or software components within one or more cloud computing environments to send, retrieve, or otherwise analyze data or information described herein. In one example, in certain aspects of the present techniques, the computing environment 100 may comprise an on-premise computing environment, a multi-cloud computing environment, a public cloud computing environment, a private cloud computing environment, and/or a hybrid cloud computing environment. In one example, an entity (e.g., a business) may host one or more services in a public cloud computing environment (e.g., Alibaba Cloud, Amazon Web Services (AWS), Google Cloud, IBM Cloud, Microsoft Azure, etc.). The public cloud computing environment may be a traditional off-premise cloud (i.e., not physically hosted at a location owned/controlled by the business). Alternatively, or in addition, aspects of the public cloud may be hosted on-premise at a location owned/controlled by the business. The public cloud may be partitioned using visualization and multi-tenancy techniques and may include one or more infrastructure-as-a-service (IaaS) and/or platform-as-a-service (PaaS) services.

A network 110 may comprise any suitable network or networks, including a local area network (LAN), wide area network (WAN), Internet, or combination thereof. In one example, the network 110 may include a wireless cellular service (e.g., 4G, 5G, etc.). Generally, the network 110 enables bidirectional communication between the servers 105, a user device 115 and one or more internet-of-things (IoT) water sensors 160. In one aspect, the network 110 may comprise a cellular base station, such as cell tower(s), communicating to the one or more components of the computing environment 100 via wired/wireless communications based upon any one or more of various mobile phone standards, including NMT, GSM, CDMA, UMTS, LTE, 5G, or the like. Additionally or alternatively, the network 110 may comprise one or more routers, wireless switches, or other such wireless connection points communicating to the components of the computing environment 100 via wireless communications based upon any one or more of various wireless standards, including by non-limiting example, IEEE 802.11a/b/c/g (Wi-Fi), Bluetooth, and/or the like.

The server 105 may include one or more processors 120. The processors 120 may include one or more suitable processors (e.g., central processing units (CPUs) and/or graphics processing units (GPUs)). The processors 120 may be connected to a memory 122 via a computer bus (not depicted) responsible for transmitting electronic data, data packets, or otherwise electronic signals to and from the processors 120 and memory 122 in order to implement or perform the machine-readable instructions, methods, processes, elements, or limitations, as illustrated, depicted, or described for the various flowcharts, illustrations, diagrams, figures, and/or other disclosure herein. The processors 120 may interface with the memory 122 via a computer bus to execute an operating system (OS) and/or computing instructions contained therein, and/or to access other services/aspects. In one example, the processors 120 may interface with the memory 122 via the computer bus to create, read, update, delete, or otherwise access or interact with the data stored in the memory 122 and/or a database 126.

The memory 122 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memory 122 may store an operating system (OS) (e.g., Microsoft Windows, Linux, UNIX, etc.) capable of facilitating the functionalities, apps, methods, or other software as discussed herein.

The memory 122 may store a plurality of computing modules 130, implemented as respective sets of computer-executable instructions (e.g., one or more source code libraries, trained ML models such as neural networks, convolutional neural networks, etc.) as described herein.

The memory 122 and/or database 126 may also store one or more data sets provided by the user. A data set may include, but is not limited to, a collection of information/data that is composed of separate elements but may be manipulated as a unit by a computer, processor 120, or the like. The data set may be related (e.g., data related to property or water usage) or unrelated, and may only have one element in some circumstances or may include multiple data sets. The term data and data set may be used interchangeably herein.

In general, a computer program or computer based product, application, or code (e.g., the model(s), such as ML models, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) 120 (e.g., working in connection with the respective operating system in memory 122) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

The database 126 may be a relational database, such as Oracle, DB2, MySQL, a NoSQL based database, such as MongoDB, or another suitable database or datastore. The database 126 may store data that is used to train and/or operate one or more ML models, provide AR models/displays, among other things.

In one aspect, the computing modules 130 may include an ML module 140. The ML module 140 may include ML training module (MLTM) 142 and/or ML operation module (MLOM) 144. In some embodiments, at least one of a plurality of ML methods and algorithms may be applied by the ML module 140, which may include, but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of ML, such as supervised learning, unsupervised learning, and reinforcement learning.

In one aspect, the ML based algorithms may be included as a library or package executed on server(s) 105. In one example, libraries may include the TensorFlow based library, the PyTorch library, and/or the scikit-learn Python library.

In one embodiment, the ML module 140 employs supervised learning, which involves identifying patterns in existing data to make predictions about subsequently received data. Specifically, the ML module is “trained” (e.g., via MLTM 142) using training data, which includes example inputs and associated example outputs. Based upon the training data, the ML module 140 may generate a predictive function which maps outputs to inputs and may utilize the predictive function to generate ML outputs based upon data inputs. The exemplary inputs and exemplary outputs of the training data may include any of the data inputs or ML outputs described above. In the exemplary embodiments, a processing element may be trained by providing it with a large sample of data with known characteristics or features.

In another embodiment, the ML module 140 may employ unsupervised learning, which involves finding meaningful relationships in unorganized data. Unlike supervised learning, unsupervised learning does not involve user-initiated training based upon example inputs with associated outputs. Rather, in unsupervised learning, the ML module 140 may organize unlabeled data according to a relationship determined by at least one ML method/algorithm employed by the ML module 140. Unorganized data may include any combination of data inputs and/or ML outputs as described above.

In yet another embodiment, the ML module 140 may employ reinforcement learning, which involves optimizing outputs based upon feedback from a reward signal. Specifically, the ML module 140 may receive a user-defined reward signal definition, receive a data input, utilize a decision-making model to generate the ML output based upon the data input, receive a reward signal based upon the reward signal definition and the ML output, and alter the decision-making model so as to receive a stronger reward signal for subsequently generated ML outputs. Other types of ML may also be employed, including deep or combined learning techniques.

The MLTM 142 may receive labeled data at an input layer of a model having a networked layer architecture (e.g., an artificial neural network, a convolutional neural network, etc.) for training the one or more ML models. The received data may be propagated through one or more connected deep layers of the ML model to establish weights of one or more nodes, or neurons, of the respective layers. Initially, the weights may be initialized to random values, and one or more suitable activation functions may be chosen for the training process. The present techniques may include training a respective output layer of the one or more ML models. The output layer may be trained to output a prediction, in one example.

The MLOM 144 may comprise a set of computer-executable instructions implementing ML loading, configuration, initialization and/or operation functionality. The MLOM 144 may include instructions for storing trained models (e.g., in the electronic database 126). As discussed, once trained, the one or more trained ML models may be operated in inference mode, whereupon when provided with de novo input that the model has not previously been provided, the model may output one or more predictions, classifications, etc., as described herein.

In operation, MLTM 142 may access database 126 or any other data source for training data suitable to generate one or more ML models. The training data may be sample data with assigned relevant and comprehensive labels (classes or tags) used to fit the parameters (weights) of an ML model with the goal of training it by example. In one aspect, once an appropriate ML model is trained and validated to provide accurate predictions and/or responses, the trained model may be loaded into MLOM 144 at runtime to process input data and generate output data.

While various embodiments, examples, and/or aspects disclosed herein may include training and generating one or more ML models for the server 105 to load at runtime, it is also contemplated that one or more appropriately trained ML models may already exist (e.g., in database 126) such that the server 105 may load an existing trained ML model at runtime. It is further contemplated that the server 105 may retrain, update and/or otherwise alter an existing ML model and before loading the model at runtime.

In one aspect, the computing modules 130 may include an input/output (I/O) module 146, comprising a set of computer-executable instructions implementing communication functions. The I/O module 146 may include a communication component configured to communicate (e.g., send and receive) data via one or more external/network port(s) to one or more networks or local terminals, such as the computer network 110 and/or the user device 115 (for rendering or visualizing) described herein. In one aspect, the servers 105 may include a client-server platform technology such as ASP.NET, Java J2EE, Ruby on Rails, Node.js, a web service or online API, responsive for receiving and responding to electronic requests.

I/O module 146 may further include or implement an operator interface configured to present information to an administrator or operator and/or receive inputs from the administrator and/or operator. An operator interface may provide a display screen. The I/O module 146 may facilitate I/O components (e.g., ports, capacitive or resistive touch sensitive input panels, keys, buttons, lights, LEDs), which may be directly accessible via, or attached to, servers 105 or may be indirectly accessible via or attached to the user device 115. According to one aspect, an administrator or operator may access the servers 105 via the user device 115 to review information, make changes, input training data, initiate training via the MLTM 142, and/or perform other functions (e.g., operation of one or more trained models via the MLOM 144).

In one aspect, the computing modules 130 may include one or more NLP modules 148 comprising a set of computer-executable instructions implementing NLP, natural language understanding (NLU) and/or natural language generator (NLG) functionality. The NLP module 148 may be responsible for transforming the user input (e.g., unstructured conversational input such as speech or text) to an interpretable format. The NLP module 148 may include NLU processing to understand the intended meaning of utterances, among other things. The NLP module 148 may include NLG which may provide text summarization, machine translation, and/or dialog where structured data is transformed into natural conversational language (i.e., unstructured) for output to the user.

In one aspect, the computing modules 130 may include one or more chatbots and/or voice bots 150 which may be programmed to simulate human conversation, interact with users, understand their needs, and recommend an appropriate line of action with minimal and/or no human intervention, among other things. This may include providing the best response of any query that it receives and/or asking follow-up questions.

In some embodiments, the voice bots or chatbots 150 discussed herein may be configured to utilize AI and/or ML techniques, such as ML chatbot 152. For instance, the ML chatbot 152 may be a ChatGPT chatbot. The voice bot or chatbot 150 may employ supervised or unsupervised ML techniques, which may be followed by, or used in conjunction with, reinforced or reinforcement learning techniques. The voice bot or chatbot 150 may employ the techniques utilized for ChatGPT.

Noted above, in some embodiments, a chatbot 150 or other computing device may be configured to implement ML, such that server 105 “learns” to analyze, organize, and/or process data without being explicitly programmed. ML may be implemented through ML methods and algorithms (“ML methods and algorithms”). In one exemplary embodiment, the ML module 140 may be configured to implement ML methods and algorithms.

As illustrated in FIG. 1, the environment 100 may include one or more IoT water sensors 160. In one embodiment, the IoT water sensors 160 may be placed proximate a property to detect water usage. The IoT water sensors 160 may be disposed on, inside, underneath, and/or proximate to an appliance, equipment, pipe, plumbing and/or fixture and may provide information related to water usage, such as the volume of water that flows through a pipe and/or plumbing. Exemplary IoT water sensors may include, without limitation, flow meters such as mechanical, vortex, ultrasonic, magnetic, Coriolis, thermal dispersion, differential pressure, positive displacement, variable area, paddle, paddle wheel, turbine, and/or any other sensor capable of sensing the flow and/or usage of water, especially at a property.

The one or more IoT water sensors 160 may be hard-wired, wirelessly, and/or otherwise connected or interconnected in any suitable manner with one another and/or with one or more servers 105, user devices 115, each or any of which may be equipped with processor(s), memory unit(s), software application(s), wireless transceiver(s), a local power supply, and/or various other components.

The one or more IoT water sensors 160 may sense, operate, or otherwise receive input and/or data in any suitable manner. This may include operating in a continuous and/or intermittent (e.g., every 5 millisecond) fashion. This may also include collecting, storing and/or transmitting data, e.g., via network 110. The data may be stored permanently or non-permanently in any suitable manner, such as on a local storage means, (e.g., RAM or a hard drive), or remotely on the server 105, in the cloud and/or another remote storage means. The one or more IoT water sensors 160 may collect, store and/or transmit data individually or collectively.

The one or more IoT water sensors 160 may communicate with one another in a wired, wireless or any other suitable manner. The communication may be continuous, intermittent, unidirectional, bidirectional or any other suitable means of communication. The one or more IoT water sensors 160 may act in concert, e.g., in creating a mesh network. The one or more IoT water sensors 160 may communicate or otherwise interface with one or more local or remote servers 105, user devices 115, processors, transceivers, each other, and/or other sensors for various purposes which may be unrelated to determining the water usage, such as for timing, scheduling, updates, error correction, troubleshooting, status reporting, or any other suitable purpose.

The IoT water sensors 160 may gather data which indicates water usage and/or may include other information, such as a sensor identifier, timestamp, or any other suitable data. In one example, the IoT water sensor 160 associated with a washing machine may indicate the amount of water the washing machine uses during one or more cycles, e.g., when detecting the amount of water flowing through a water line attached to the washing machine. In one aspect, an appliance may be a smart appliance which may include one or more sensors providing data about the appliance such as when it is running, which may also include how much water the appliance uses while running, among other things.

The environment 100 may include one or more water meters 165. The water meter 165 may measure the amount of water from a water supply system, such as a public and/or municipal water supply system, a property uses. The water meter 165 may be located at and/or attached to the main water line entering a property. The water supplier may provide, own, maintain and/or read the water meter 165. The water usage information the water meter 165 provides may be used to generate a bill, indicate water usage of the property, and/or any other suitable purpose. The water meter 165 may provide water usage information on the water meter 165, e.g., via numerical rolling dials similar to a vehicle odometer and/or on a digital display, may transmit usage information in a wired and/or wireless manner as data to a device such as a meter reader, a server, and/or provide water usage information in any other suitable manner.

The one or more servers 105, IoT water sensors 160, and/or water meters 165 may also be in communication with one or more user devices 115, e.g., a user device associated with an owner of the home 102. The user device 115 may comprise one or more computers, which may comprise multiple, redundant, or replicated client computers accessed by one or more users. The user device 115 may access services or other components of the computing environment 100 via the network 110. The user device 115 may be any suitable device and include one or more mobile devices, wearables, smart watches, smart contact lenses, smart glasses, AR glasses/headsets, virtual reality (VR) glasses/headsets, mixed or extended reality glasses/headsets, voice bots or chatbots, ChatGPT bots, displays, display screens, visuals, and/or other electronic or electrical component. The user device 115 may include a memory and a processor for, respectively, storing and executing one or more modules. The memory may include one or more suitable storage media such as a magnetic storage device, a solid-state drive, random access memory (RAM), etc. The user device 115 may access services or other components of the computing environment 100 via the network 110, as further described herein.

In one embodiment, the computer environment 100 may detect anomalous water usage at a property having a water supply system using ML. The server 105 may obtain a property data set for a property, such as the home 102. The property data set may comprise property data the server obtains from one or more sources. In one aspect, the server 105 may obtain the property data from public records such as a real estate listing, property records, etc. In one aspect, the server 105 may obtain the property data from the homeowner via user device 115. The server 115 may provide the property data set to an ML model trained to generate an estimated water usage of the property associated with the property data set. The ML model may be trained using historical training data, e.g., stored in database 126 of server 115. The ML module 140 may train the ML model using the historical training data. The historical training data may include historical water usage data set indicating historical water usage of a plurality of properties water and/or historical property data set including attributes of the plurality of properties influencing the water usage of the plurality of properties. The ML module 140 may train the ML model, e.g., via MLTM 142, to learn relationships between the historical water usage data set and the historical property data set.

The server 105 may obtain a water usage data set of the property indicating water usage of the property. The server 105 may obtain the water usage data from the property owner, e.g., via user device 115, from a water supplier, or any other suitable source. The server 105 may compare the water usage and the estimated water usage of the property, and generate a notification based upon the water usage and the estimated water usage comparison exceeding a threshold. The comparison may indicate a leak at the property (e.g., if the water usage exceeds the estimated usage), inaccurate water usage readings, e.g., if the water usage information the water supplier provides is inconsistent with water usage detected by the IoT water sensors 160, water meter 165, and/or historical water usage for the property or properties having similar attributes. The server 105 may provide the notification to a user device 115, such as user device 115 of the homeowner.

The computing environment 100 may include additional, fewer, and/or alternate components, and may be configured to perform additional, fewer, or alternate actions, including components/actions described herein. Although the computing environment 100 is shown to include two user devices 115, one server 105, and one network 110, and three IoT water sensors 160, it should be understood that different numbers of user devices 115, networks 110, servers 105, and/or IoT water sensors 160 may be utilized. In one example, the computing environment 100 may include a plurality of servers 105 and hundreds or thousands of user devices 115 and/or IoT water sensors 160, all of which may be interconnected via the network 110. Likewise, information described as being stored at server database 126 may be stored at memory 122, and thus database 126 may be omitted. Moreover, various aspects include the computing environment 100 including any suitable additional component(s) not shown in FIG. 1, such as but not limited to the exemplary components described above. Furthermore, it should be appreciated that additional and/or alternative connections between components shown in FIG. 1 may be implemented. As just one example, server 105 and user device 115 may be connected via a direct communication link (not shown in FIG. 1) instead of, or in addition to, via network 110.

### Exemplary Mobile Device

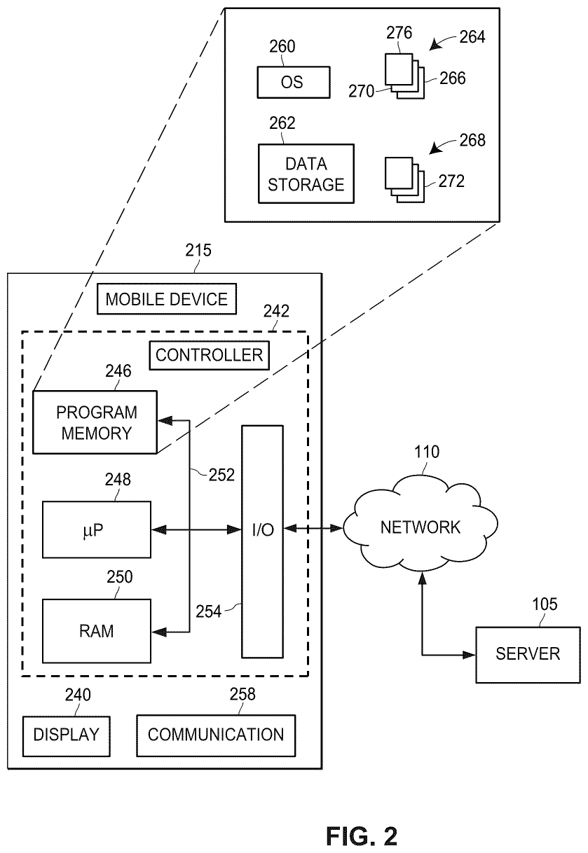

Referring now to FIG. 2, in one embodiment the user device 115 may include a mobile device 215. The exemplary mobile device 215 may include a display 240, a communication unit 258, a user-input device (not shown), and a controller 242. The controller 242 may include a program memory 246, a microcontroller/processor/microprocessor (uP) 248, a random-access memory (RAM) 250, and/or an input/output (I/O) circuit 254, all of which may be interconnected via an address/data bus 252. The program memory 246 may include an operating system 260, a data storage 262, a plurality of software applications 264, and/or a plurality of software routines 268. The operating system 260, in one example, may include one of a plurality of mobile platforms such as the iOS®, Android™, Palm® webOS, Windows Mobile/Phone, BlackBerry® OS, or Symbian® OS mobile technology platforms, developed by Apple Inc., Google Inc., Palm Inc. (now Hewlett-Packard Company), Microsoft Corporation, Research in Motion (RIM), and Nokia, respectively.

The data storage 262 may include data such as user profiles, application data for the plurality of applications 264, routine data for the plurality of routines 268, and/or other data necessary to interact with the one or more servers 105 through the network 110. In some embodiments, the controller 242 may also include, or otherwise be communicatively connected to, other data storage mechanisms (e.g., one or more hard disk drives, optical storage drives, solid state storage devices, etc.) that reside within the mobile device 215.

The communication unit 258 may communicate with the one or more servers 105 via any suitable wireless communication protocol network, such as a wireless telephony network (e.g., GSM, CDMA, LTE, 5G, 6G, UWB etc.), a Wi-Fi network (802.11 standards), a WiMAX network, a Bluetooth network, etc. The user-input device (not shown) may include a “soft” keyboard that is displayed on the display 240 of the mobile device 215, an external hardware keyboard communicating via a wired and/or a wireless connection (e.g., a Bluetooth keyboard), an external mouse, a touchscreen, a stylus, and/or any other suitable user-input device.

As discussed with reference to the one or more servers 105, it should be appreciated that although FIG. 2 depicts only one microprocessor 248, the controller 242 may include multiple microprocessors 248. Similarly, the memory of the controller 242 may include multiple RAMs 250 and/or multiple program memories 246. Although FIG. 2 depicts the I/O circuit 254 as a single block, the I/O circuit 254 may include a number of different types of I/O circuits. The controller 242 may implement the RAM(s) 250 and/or the program memories 246 as semiconductor memories, magnetically readable memories, and/or optically readable memories, in one example.

The one or more processors 248 may be adapted and/or configured to execute any one or more of the plurality of software applications 264 and/or any one or more of the plurality of software routines 268 residing in the program memory 242, in addition to other software applications. One of the plurality of applications 264 may be a client application 266 that may be implemented as a series of machine-readable instructions for performing the various tasks associated with receiving information at, displaying information on, and/or transmitting information from the mobile device 215.

One of the plurality of applications 264 may be a native application and/or web browser 270, such as Apple's Safari®, Google Chrome™ mobile web browser, Microsoft Edge® for Mobile, Opera Mobile™, that may be implemented as a series of machine-readable instructions for receiving, interpreting, and/or displaying application screens or web page information from the one or more servers 105 while also receiving inputs from the user. Another application of the plurality of applications may include an embedded web browser 276 that may be implemented as a series of machine-readable instructions for receiving, interpreting, and/or displaying web page information.

In one aspect, a user may launch a client application 266 from a client device, such as one of the user devices 115, to communicate with the one or more servers 105 which detect anonymous water usage at a property (such as the home 102), access a water usage dashboard, review actionable information, and/or provide water usage validation, among other things. Additionally, the property owner and/or the user may also launch or instantiate any other suitable user interface application (e.g., the native application or web browser 270, and/or any other one of the plurality of software applications 264) to access the one or more servers 105 to realize aspects of the inventive system.

One of the plurality of routines may include a water usage routine 272 that may display information about the water usage of the property and provide notification upon detection of anomalous water usage, which may indicate a leak. In some embodiments, the water sensor routine 272 may launch automatically upon receiving a notification, message and/or other signal from one or more IoT water sensors 160 and/or servers 105.

Generally, the term “user” is used when referring to a person who is operating one of the user devices 115 and is not exclusive of the term “property owner,” “property owner,” and/or “service provider.”

The mobile device 215 may include additional, fewer, and/or alternate components, and may be configured to perform additional, fewer, or alternate actions, including components/actions described herein. Although the mobile device 215 is shown in FIG. 2 as including one instance of various components such as display 240, processor 248, etc., various aspects include the mobile device 215 implementing any suitable number of any of the components shown in FIG. 2 and/or omitting any suitable ones of the components shown in FIG. 2. Moreover, various aspects include the mobile device 215 including any suitable additional component(s) not shown in FIG. 2, such as but not limited to the exemplary components described above. Furthermore, it should be appreciated that additional and/or alternative connections between components shown in FIG. 2 may be implemented.

### Exemplary AR Device

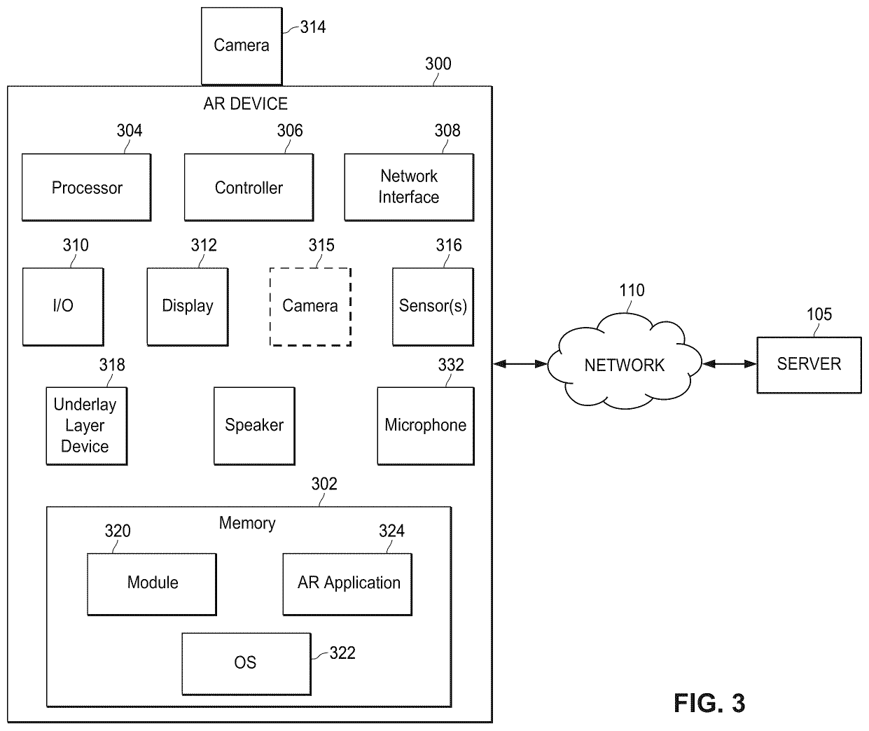

FIG. 3 depicts an exemplary AR viewer device 300 that may implement the techniques described herein, for visualizing water usage information. The AR viewer device 300 may be, in one example, a smartphone, tablet device, laptop computer, electronic contact lenses, a projector, glasses, googles, a headset such as the Google Glass, a mixed-reality (MR) headset such as the Microsoft HoloLens, and/or other suitable computer device.

The AR viewer device 300 may include a memory 302, a processor (CPU) 304, a controller 306, a network interface 308, an I/O module 310, a display 312, cameras 314, 315, sensors 316, an underlay layer device 318, a speaker 330 and/or a microphone 332.

The memory 302 may include one or more memories, such as a non-transitory, computer readable memory comprising computer-executable instructions that, when executed, cause the AR viewer device 300 to perform actions thereof described in this description (e.g., via the processor 304, controller 306, display 312 and/or other components of the AR viewer device 300). The memory 302 may comprise one or more memory modules 320 such a random-access memory (RAM), read-only memory (ROM), flash memory, a hard disk drive (HDD), a solid-state drive (SSD), flash memory, MicroSD cards, and/or other types of suitable memory.

The memory 302 may store an operating system (OS) 322 (e.g., Microsoft Windows Mixed Reality Platform, Linux, Android, IOS, UNIX, etc.) capable of facilitating the functionalities, applications, methods, or other software as discussed herein. Memory 302 may also store one or more applications to, e.g., for visualizing water usage of property. In one embodiment, memory 302 may store an AR application 324 which may, among other things, present AR displays to the display 312 of AR viewer device 300 as described in more detail herein. Additionally, or alternatively, the memory 302 may store data from various sources, e.g., AR displays, virtual models, overlay layer data, property data, water usage data, water usage dashboard, as well as any other suitable data.

The processor 304 may include one or more local or remote processors, which may be of general-purpose or specific-purpose. In some embodiments this may include one or more microprocessors, ASICs, FPGAs, systems-on-chip (SoCs), systems-in-package (SiPs), graphics processing units (GPUs), well as any other suitable types of processors. During operation, the processor 304 may execute instructions stored in the program memory module 302 coupled to the processor 304 via a system bus of a controller 306.

The AR viewer device 300 may further include the controller 306. The controller 306 may receive, process, generate, transmit, and/or store data and may include and/or be operably connected to (e.g., via the system bus) the memory 302, the processor 304, and/or the I/O module 310, as well as any other suitable components.

The AR viewer device 300 may further include a network interface 308, which may facilitate communications to and/or from the AR viewer device 300 with one or more devices and/or networks, such as the server 105 via network 110. The network interface 308 may include one or more transceivers and/or modems, and may facilitate any suitable wired or wireless communication, standard or technology, such as GSM, CDMA, TDMA, WCDMA, LTE, EDGE, OFDM, GPRS, EV-DO, UWB, 3G, 4G, 5G, IEEE 802 including Ethernet, WiMAX, Wi-Fi, Bluetooth, and/or other suitable communication.

The I/O module 310 (i.e., one or more input and/or output units) may include, interface with and/or be operably connected to, in one example, one or more input devices such as a touchpad, a touchscreen, a keyboard, a mouse, a camera 314, 315, underlay layer device 318, and/or microphone 332, as well as one or more output devices such as a display 312, a speaker 330, a haptic/vibration device, and/or other suitable input and/or output devices. In some embodiments, the I/O module 310 may include one or more peripheral I/O devices, such as a peripheral display, microphone 332, camera 314, 315, sensors 316 and/or other interface devices operably connected to the AR viewer device 300 (e.g., via a wired or wireless connection) via the I/O module 310. Although FIG. 3 depicts the I/O module 310 as a single block, the I/O module 310 may include a number of different I/O circuits, busses and/or modules, which may be configured for I/O operations.

One or more cameras 314, 315 may capture still and/or video images of the physical environment of the AR viewer device 300. The cameras 314, 315 may include digital cameras, such as charge-coupled devices, to detect electromagnetic radiation in the visual range or other wavelengths. In some embodiments, as depicted in FIG. 3, one or more interior cameras 315 may be located on the interior of the AR viewer device 300, e.g., for tracking the eyes of the user via OS 322 and/or AR application 324. The AR viewer device 300 may include one or more exterior cameras 314 located on the exterior of AR viewer device 300, e.g., for user hand tracking, object identification, and/or localization within the physical environment via OS 322 and/or AR application 324. In other embodiments, one or more of the cameras (not shown) may be external to, and operably connected with (e.g., via I/O module 310, Bluetooth and/or Wi-Fi) the AR viewer device 300. The captured images may be used to generate AR displays, augmented environments, and the like. In some embodiments, two or more cameras, such as external cameras 314, may be disposed to obtain stereoscopic images of the physical environment, thereby better enabling the AR viewer device 300 to generate virtual space representations of the physical environment, and/or overlay augmented information onto the physical environment.

The display 312, along with other integrated or operably connected devices, may present augmented and/or virtual information to a user of the AR viewer device 300, such as an AR display. The display 312 may include any known or hereafter developed visual or tactile display technology, including LCD, LED, OLED, AMOLED, a projection display, a haptic display, a holographic display, or other types of displays. In some embodiments, the display 312 may include dual and/or stereoscopic displays, e.g., one for presenting content to the left eye and another for presenting content to the right eye. In some embodiments, the display 312 may be transparent allowing the user to see the physical environment around them, e.g., for implementing AR techniques in which an AR display may be overlaid on the physical environment.

According to one embodiment of FIG. 3, the AR viewer device 300 may present one or more AR displays via the display 312. In one example, the display 312 may be a surface positioned in a line of sight of the wearer of the AR viewer device 300. Accordingly, the AR viewer device 300 may be configured to overlay augmented information included in the AR display onto features of the physical environment within the line of sight of the wearer of the AR viewer device 300. To determine the line of sight of the wearer, the AR viewer device 300 may include an image sensor (such as an external camera 314 and/or underlay layer device 318) configured to have a field of view that generally aligns with the line of the sight of the wearer. In one embodiment, the AR viewer device 300 may be configured to route the image data to the server 105 to generate an AR display that includes information related to objects within the line of sight of the wearer. In one example, the server 105 may include one or more object classification models configured to identify one or more objects within the received image data and provide the classification data back to the AR viewer device to present an AR display that includes at least a portion of the classification data.

The AR viewer device 300 may further include one or more sensors 316. In some embodiments, additional local and/or remote sensors 316 may be communicatively connected to the AR viewer device 300. The sensors 316 may include any devices or components mentioned herein, other devices suitable for capturing data regarding the physical environment, and/or later-developed devices that may be configured to provide data regarding the physical environment (including components of structures or objects within the physical environment).

Exemplary sensors 316 of the AR viewer device 300 may include one or more accelerometers, gyroscopes, inertial measurement units (IMUs), GPS units, proximity sensors, cameras 314, 315 microphones 332, as well as any other suitable sensors. Additionally, other types of currently available or later-developed sensors may be included in some embodiments. One or more sensors 316 of the AR viewer device 300 may be configured for localization, cyc/hand/head/movement tracking, geolocation, object recognition, computer vision, photography, positioning and/or spatial orientation of the device, as well as other suitable purposes. The sensors 316 may provide sensor data regarding the local physical environment which may be used to generate a corresponding AR display, as described herein, among other things.

AR viewer device 300 may further include underlay layer device 318 configured to generate underlay layer data from the field of view of the wearer. As will be described elsewhere herein, the underlay layer data may be analyzed to create the AR display. In one illustrative example, the underlay layer device 318 may be camera, such as camera 314, coupled to the AR viewer device 300 in a manner such that the camera has a field of view that generally aligns with the field of view of a user of the AR viewer device 300. As used herein, the word “camera” should be understood to include a camera that records one or both of images and/or video data. In certain embodiments where the AR viewer device 300 is a phone or a tablet, the underlay layer data device 318 may be built into the AR viewer device 300. In some embodiments where the AR viewer device 300 is worn by the user, the underlay layer data device 318 may be fixedly attached to the AR viewer device 300.

In one embodiment, the AR viewer device 300 or other device may process data from one or more sensors 316 to generate a semi-virtual environment. In one example, data from one or more sensors 316, such as cameras 314, 315, underlay layer device 318, accelerometers, gyroscopes, IMUs, etc., may be processed, e.g., at the server 105 and/or at the AR viewer device 300, which may include AR application 324, to determine aspects of the physical environment which may include object recognition, the orientation and/or localization of the AR viewer device 300, the field of view of the user, among other things. In one embodiment, the sensor data may be combined with image data generated by the cameras 314, 315 and/or underlay layer device 318 to present AR displays via the display 312 of the AR viewer device 300 using the AR application 324, which may include displaying and/or overlaying images, models, instructions, animations, video, multimedia and/or other digitally-generated content onto the physical environment via the display 312.

The AR viewer device 300 may include one or more speakers 330 configured to emit sounds and one or more microphones 332 configured to detect sounds. The one or more speakers 330 and/or microphones 332 may be disposed on the AR viewer device 300 and/or remotely from, and operably connected to, the AR viewer device 300, e.g., via a wire and/or wirelessly. In one embodiment, the speaker 330 and/or microphone 332 may be configured to provide multimedia effects in conjunction with an AR display, receive voice commands e.g., to control the AR viewer device 300, among other things.

In one embodiment, AR viewer device 300 may receive and/or access overlay layer data (e.g., data stored in a database, such as database 126) to create the AR display. In one example, the database 126 on server 105 may be configured to store property data associated with a home. The property data set may include a floorplan of the property, and/or information describing the property, appliances, items and/or objects associated with the property, water sources at the property and/or water usage at the property, among other things. The overlay layer data may be correlated (e.g., on the server 105) with the underlay layer data (e.g., from the underlay layer device 318) to create the AR display. In one example, a user of the AR viewer device 300 may have access to a floorplan via property data and water usage for certain appliances at a property via IoT water sensors providing water usage data of the property. The AR viewer device 300 and/or server 105 may process the underlay layer data generated via underlay layer data device 318, data from sensors 316 such as locations via a GPS sensor, orientation data from an orientation sensor and/or overlay layer data of the floorplan. The AR viewer device 300 and/or server 105 may correlate the overlay layer data, underlay layer data and/or sensor data to generate an AR display, identify the location of the AR viewer device 300, and/or any other suitable purpose. The AR display may identify the user's location at the property, objects in the field of view of the user (e.g., appliances using water) via object recognition, associated water usage of identified appliances or other objects of the property, and/or provide other suitable information. In one example, a user may be able to walk around their home and have the AR viewer device 300 overlay information received via server 105 onto one or more appliances indicating the water usage of that appliance (e.g., for the month), how the water usage may compare to historical water, and/or tips to mitigate excessive water usage, as well as other suitable information which may relate to water usage at the property.

In some embodiments, the AR viewer device 300 may be a personal electronic device, such as a smartphone or tablet. In one example, the personal electronic device may be configured to execute the AR application 324 in which a rear-facing camera captures image data of the physical environment proximate to the AR viewer device 300 and overlays AR data onto the display 312. Accordingly, in these embodiments, the functionality of the AR viewer device 300 and/or the personal electronic device may be integrated at a single device.

In other embodiments, the AR viewer device 300 may include a base unit coupled to an AR viewer. In one example, the base unit may be integrally formed with the AR viewer, such as in a frame that supports the display 312. In other embodiments, the base unit and the AR viewer are physically separate and in wireless communication (e.g., via Bluetooth, Wi-Fi, or other short-range communication protocol) or wired communication with one another. In these embodiments, both the base unit and the AR viewer may include local versions of the components described with respect to the AR viewer device 300. In one example, both the base unit and the AR viewer may include respective memories 302, processors 304, controllers 306, network interfaces 308, and/or sensors 316. Accordingly, the respective memories 302 may include respective versions of the AR application 324 that coordinate the execution of the functionality described herein between the AR viewer and the base unit.

Generally, the AR application 324 may utilize the components of the base unit to perform the more processor-intensive functionality described with respect to the AR viewer device 300. In one example, the base unit may be configured to process sensor data, wirelessly communicate with the server 105, create AR displays, etc. On the other hand, the AR application 324 may utilize the components of the viewer device to transmit sensor data to present AR displays via the display 312.

The AR viewer device 300 may include a power source (not shown), such as a rechargeable battery pack. The power source may be integral to the AR viewer device 300 and/or may be a separate power source within the base unit and operably connected to the AR viewer device 300.

The AR viewer device 300 may include additional, fewer, and/or alternate components, and may be configured to perform additional, fewer, or alternate actions, including components/actions described herein. Although the AR viewer device 300 is shown in FIG. 3 as including one instance of various components such as processor 304, underlay layer device 318, etc., various aspects include the AR viewer device 300 implementing any suitable number of any of the components shown in FIG. 3 and/or omitting any suitable ones of the components shown in FIG. 3. Moreover, various aspects include the AR viewer device 300 including any suitable additional component(s) not shown in FIG. 3, such as but not limited to the exemplary components described above. Furthermore, it should be appreciated that additional and/or alternative connections between components shown in FIG. 3 may be implemented.

### Exemplary Ml Model to Generate Estimated Water Usage of a Property

In one embodiment, an ML model may be trained to generate an estimated water usage of a property associated with the property data set. The property may include a home, business, and/or other property which may be suitable for estimating water usage. The water usage information may be valuable to a property owner or other party to provide evidence of a leak, indicate whether the water usage at the property is conservative, average or excessive, understand how different attributes of the property may affect water usage, among other things.

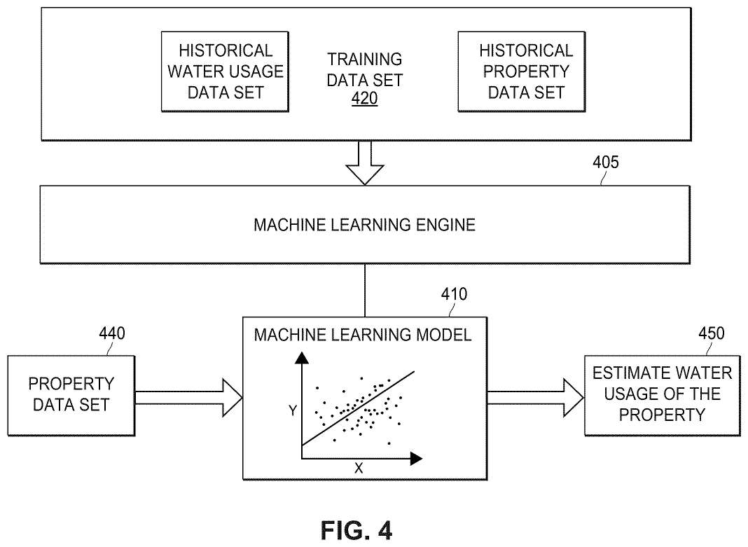

FIG. 4 schematically illustrates how an ML model may generate estimated water usage of the property based upon the property data set. Some of the blocks in FIG. 4 represent hardware and/or software components (e.g., block 405), other blocks represent data structures or memory storing these data structures, registers, or state variables (e.g., block 420), and other blocks represent output data (e.g., block 450). Input signals are represented by arrows labeled with corresponding signal names.

The ML engine 405 may include one or more hardware and/or software components, such as the MLTM 142 and/or the MLOM 144, to obtain, create, (re) train, operate and/or save one or more ML models 410. To generate the ML model 410, the ML engine 405 may use the training data set 420. As described herein, the server such as server 105 may obtain and/or have available one or more types of training data comprising a training data set 420 (e.g., stored on database 126 of server 105). In one aspect, at least some of the training data 420 may be labeled to aid in training and/or fine-tuning the ML model 410.

In one embodiment, the training data set 420 may include historical data for a plurality of properties. In one aspect, the training data set 420 may include a historical water usage data set indicating historical water usage of a plurality of properties. In one aspect, the historical water usage data set may be crowd-sourced. In one example, the historical water usage data may include a plurality of historical water usage data entries corresponding to the plurality of properties, which may be provided by a plurality of data providers associated with a corresponding property of the plurality of properties, e.g., property owners, utility companies such as a water supplier, municipalities, and/or other suitable entity. This data may be uploaded and/or stored on a database, such as database 126. In one aspect, the historical water usage data may be made accessible to public and/or private entities for free and/or for a fee, such as a subscription fec. In one example, a water supplier may provide data on historical water usage for the properties it serves. In one example, a property owner may choose to upload their water usage data, e.g., for access by others in the community. In one aspect the water usage data may be anonymized, e.g., to remove any information which may identify the specific property or property owner associated with the historical water usage data.

In one aspect, the training data set 420 may include a historical property data set including attributes of the plurality of properties influencing water usage of the plurality of properties. The attributes indicated by property data comprising the property data set which may influence the water usage at any of the plurality of properties may include one or more of the size of the property, the size of the household of the property, appliances of the property (e.g., the number of appliances which use water, how much water each appliance uses, etc.), climate of the property (e.g., cold weather properties may use more water for convection-based heating systems during cold months), and/or water features of the property (e.g., pools, hot tubs, ponds, fountains, irrigation systems, etc.). In one aspect, the system, such as server 105, may obtain some or all of the property data comprising the property data set from property owners, publicly available resources (e.g., property records, real estate listings, census data, satellite maps, etc.), or any other suitable source.

In one aspect, the training data set 420 may include data one or more users provide via the water usage dashboard, as described herein. The water usage dashboard data may validate water usage of a property, provide insights into water usage trends, and/or provide other information which may be suitable to train the ML model 410 to predict water usage at the property. The historical water usage data set may include any other data which may be useful for training the ML model 410.

The ML model 410 may be configured to process the training data set 420 to learn relationships in the training data, e.g., relationships between the historical water usage data set, the historical property data set and/or other training data. In one example, the historical training data set may indicate, when processed by a trained ML model such as ML model 410, that on average a two-story, 2,600 sq. ft. home located in the pacific northwest of the United States with two bathrooms, a five member household, and a pool may generally use about 15,000 gallons of water per month during the summer season.

While the example training data set 420 includes indications of various types of data such as water usage data and property data, this is merely an example for ease of illustration only. The training data set 420 may include any suitable data which may indicate relationships between the historical water usage data set and the historical property data set, as well as any other suitable data which may train the ML model 410 to generate an estimated water usage of the property 450.

In one aspect, the server may continuously update the training data set 420, e.g., to include new data indicative of relationships between the historical water usage data set and the historical property data set, or any other suitable training data. Subsequently, the ML model 410 may be retrained based upon the updated training data set 420. Accordingly, generating the estimated water usage of the property 450 may improve over time.

In one aspect, the ML engine 405 may process and/or analyze the training data set 420 (e.g., via MLTM 142) to train the ML model 410 to generate an estimated water usage of the property 450 associated with the property data set 440. The ML model 410 may be trained via regression, k-nearest neighbor, support vector regression, and/or random forest algorithms and/or models, although any type of applicable ML algorithm and/or model may be used, including training using one or more of supervised learning, unsupervised learning, semi-supervised learning, and/or reinforcement learning.

Once trained, the ML model 410 may perform operations on one or more data inputs to produce a desired data output. In one aspect, the ML model 410 may be loaded at runtime (e.g., by MLOM 144) from a database (e.g., database 126 of server 105) to process the property data set 440 as the input. The property data set 440 may be similar to the historical property data set. The server, such as server 105, may obtain the property data set 440 and use it as an input to generate an estimated water usage of the property 450 which is associated with the property data set 440. In one aspect, the server may obtain the property data set 440 via user input on a user device. In one aspect, the property owner may provide information via mobile device 215 which may be running a mobile application (app) associated with a water usage estimate, by accessing a website and/or chatbot to provide the property data set 440, and/or other suitable means. In one aspect, the server may obtain the property data set 440 from public and/or property databases or resources associated with the property, such as government/municipal databases of land/property records; business records, such as a real estate property listing or insurance company having information on an insured property, as well as other suitable sources of the property data set 440. For example, a user of the system may provide only their address as the property data set 440 input to ML model 410. The system may use the address to obtain other property data relevant to the property associated with the address. The ML model 410 may process the property data set 440 including the user-provided data and system-obtained property data to generate the estimate of water usage 450 for the property associated with the user-provided address.

In one embodiment, the ML model 410 may weight one or more attributes of the property data set 440 such that they are of unequal importance when generating the estimate of water usage at the property 450. In one aspect, the weights may be determined during training of the ML model 410. In one example, the household size may be a better indicator of estimated water usage for a property than whether the property has a decorative water fountain as part of the landscaping, thus the household size may be given more weight by the ML model 410 when determining an estimate of water usage 450.

In one embodiment, the ML model 410 may use a regression model to determine a number associated with a quantity (e.g., gallons per month) of estimated water usage for a property 450 based upon the property data set 440 input. In one aspect, the ML model 410 may process the property data set 440, which may include attributes of the property influencing the water usage of the property, to generate the estimate of water usage for the property 450. Once the estimate of water usage for the property 450 is generated by the ML model 410, it may be provided to a user device such as mobile device 215 of the property owner. In one aspect the estimated water usage data 450 may be further processed by the server, such as server 105, e.g., to compare against a water usage data set for the property and/or provide various water usage analytics and the like at a water usage dashboard, as further described herein. In one example, the server may provide the estimated water usage data 450 to a property owner via a mobile app of mobile device 215, an email, a graphical user interface on an AR device (such as the AR viewer device 300), a website (e.g., on a water usage dashboard), via a chatbot (such as an ML chatbot), and/or in any other suitable manner as further described herein.

### Exemplary System for Detection of Anomalous Water Usage at a Property

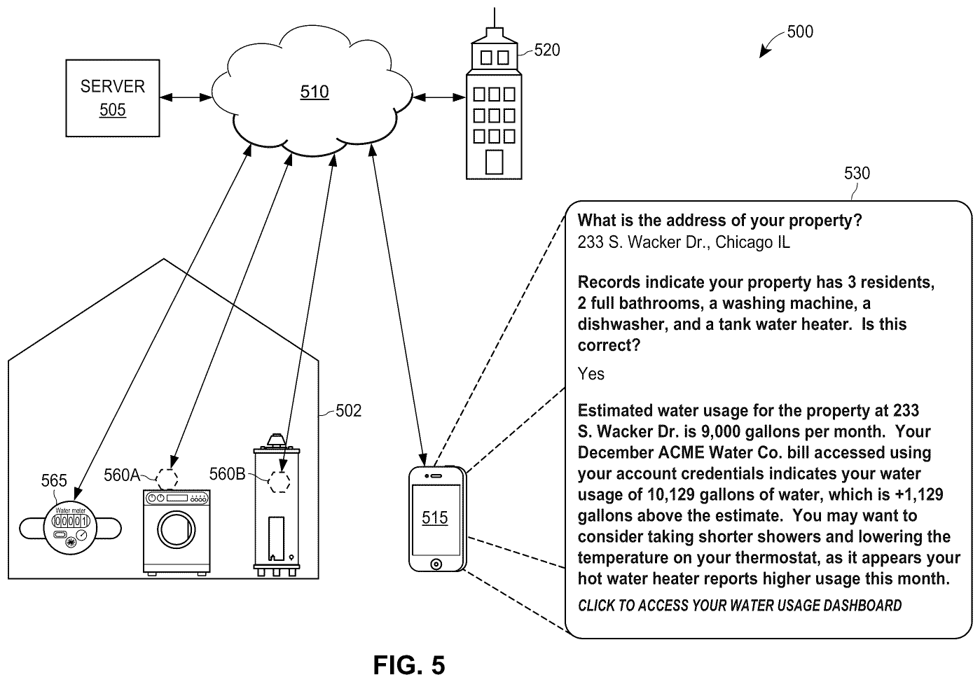

FIG. 5 depicts an exemplary block diagram of a system 500 for detection of anomalous water usage at a property, according to an embodiment. The system 500 may include a server 505 such as server 105, a network 510 such as network 110, a smartphone 515 such as mobile device 215, IoT sensors 560A, 560B such as IoT sensor 160, and a water meter 565 such as water meter 165.

The system 500 may obtain a property data set associated with the property 502, which may include attributes of the property 502 influencing water usage of the property 502. In one example, a user may provide information associated with the property 502 to the system 500, e.g., via smartphone 515. This may include an address, coordinates, lot number, and/or other information associated with the property. The system 500 may obtain property data from one or more sources based upon the user-provided information, which may include public and/or proprietary sources such as websites, databases, business records, maps, images, real estate listings, or other suitable sources of property data.

In one aspect, the property data may directly and/or indirectly indicate attributes of the property 502 which may affect water usage. In one example, blueprints, schematics, satellite images and the like may indicate and/or be used by the system 500 to determine the size of a property 502, number of bathrooms and/or whether the property 502 includes a pool or other water feature. In one example, the system 500 may obtain census data which may indicate how many people reside at the address associated with the property 502. In one example, the system 500 may use the address of the property 502 provided by the customer to determine an associated climate of the property 502. In one aspect, the property owner, resident and/or other party may provide information related to the property 502 which may indicate attributes influencing water usage at the property 502, e.g., via a mobile app, a website, and/or the water usage dashboard. Any other suitable method for the system 500 to obtain a property data set comprising property data may be considered by the disclosed systems, methods and techniques.

The system 500, e.g., via server 505, may provide the property data set to an ML model trained to generate an estimated water usage of the property 502 associated with the property data set, such as ML model 410. The ML model may be stored in a memory of the system 500, e.g., the server 505 which may include a database such as the database 126 and/or a memory such as memory 122. The server 505 may load the ML model at runtime, e.g., into MLOM 144, and provide the property data set to the ML model which generates the estimated water usage for the property 502.

In one embodiment, the system 500, e.g., via server 505, may obtain a water usage data set for the property. In one example, the water usage data set may comprise water usage data from the water meter 565 and/or IoT water sensors 560A, 560B. In one aspect, the water meter 565 may detect the aggregate water usage for the property 502. In one aspect, the water meter 565 may display and/or convey the water usage information on the water meter 565 (e.g., via a display or dials), as described herein, such that a homeowner may physically read the water meter 565. In one aspect, the water meter 565 may report the water usage electronically as water usage data. In one example, an electronic meter reading device, e.g., associated with the water supplier 520 and/or property owner, may obtain the water usage data from the water meter 565. In one example, the water meter 565 may transmit water usage data via network 510 to the water supplier 520. In either example, the water supplier 520 may in-turn provide the water usage data for the property 502 to the property owner, e.g., as a water usage report or part of a water bill. In one example, the water usage report and/or water bill may be available to the property owner electronically via a mobile app and/or website associated with the water supplier 520. The system 500 may obtain the water usage data provided by the water meter 565 from the water supplier 520, from the property owner, directly from the water meter 565, and/or in any other suitable manner.

In one aspect, IoT water sensors such as IoT sensors 560A, 560B, may provide water usage data for specific appliances, objects, and/or water lines of the property 502. In the example according to FIG. 5, IoT water sensor 560A may detect the amount water used by a washing machine and IoT water sensor 560B may detect the amount of water used by a hot water heater. The IoT sensors 560A, 560B may provide the water usage data to the server 505, e.g., via network 510, indicating the associated water usage for each sensor 560A, 560B. In one aspect, the IoT water sensors 560A, 560B may provide water usage data to the property owner or other party, who may in-turn may provide the water usage data to the system 500 via an associated mobile app, website, water usage dashboard, and/or in another suitable manner. The system 500 may obtain the water usage data set in any suitable manner according to the systems and methods of the present techniques.

In one embodiment, the system 500, e.g., via server 505, may compare the water usage of the property 502 indicated by the water usage data set with the estimated water usage for the property which 502 the ML model generates. The system 500 may generate a notification based upon the comparison. The notification may include analytics and/or actionable information. In one aspect, the system 500 may only generate the notification if the comparison exceeds a threshold. A system 500 user, such as the property owner, may set the threshold via the water usage dashboard, a mobile app and/or website associated with the system 500, and/or in any other suitable manner. The system 500, e.g., server 505 via network 510, may provide the notification to a user device, such as smartphone 515.

In one aspect, the threshold may be a specific value of water usage, which if exceeded, may cause the system 500 to generate a notification. In one example, a property owner may want to know if the property 502 water usage exceeds 12,000 gallons per month, and thus set that value as a threshold to trigger a notification. In one aspect, the threshold may be a value indicating a difference from the previous month's water usage, e.g., if the difference in water usage at the property is more or less than 2,000 gallons as compared to the last month. In one example, water usage may change seasonally, e.g., using an irrigation system in the warmer months may increase water usage at a property. Accordingly, a user may set a threshold for the system 500 to generate a notification which may trigger once the irrigation system begins to run for the season, but may not receive the notification in the subsequent months when it continues to operate. In one aspect, the system may only generate a notification when the difference between the estimated water usage and actual water usage for the property 502 exceeds the threshold. Such a notification may indicate conservative water usage if actual water usage is below the estimate, which may indicate members of the household are on vacation or the like. If the property owner validates the conservative water usage information with such an explanation, the feedback may be used to train and/or fine-tune the ML model. In one aspect, the notification may indicate excessive water usage if the comparison exceeds the water usage estimate. In one example, this may indicate to the property owner that a leak is present on the property 502 if they have no way to validate the excessive water usage. The system 500 may use any suitable value as a threshold and/or trigger for comparison and/or notification purposes.

In one embodiment, the notification may include actionable information. In one aspect, the actionable information may include one or more recommended actions to reduce the water usage of the property based upon the water usage and the estimated water usage comparison. In one example, the notification may include one or more water conservation suggestions, such as reducing water use by taking shorter showers, watering the lawn less often, suggesting water efficient appliances or devices (e.g., shower heads), or any other water conservation suggestion. The notification may be specific to the attributes of the user's property which may be known from the property data set and/or water usage data set. In one example, an IoT sensor may be associated with a shower head and provide water usage and shower duration data. The system 500 may process the IoT water sensor data to determine a different shower head may be more water-efficient and provide a notification with a suggestion to the property owner to change the shower head to conserve water.

In one aspect, the notification may indicate that the property 502 may have a leak which may cause anomalous water usage. The system 500 may determine the possibility of a leak based upon analysis of the property data set and/or water usage data set. In one example, the property data set and/or water usage data set may indicate there is an irrigation system at a property 502. An IoT water sensor at the property 502 may be attached to the waterline feeding the irrigation system. The irrigation system may be smart appliance which may transmit its water usage to the server 505. The system 500 may analyze the water usage data from the IoT sensor and the smart irrigation system to determine that more water is passing through the waterline feeding the irrigation system than the irrigation system reports as being used. The system 500 may determine based upon the discrepancy that water may be leaking somewhere between the IoT water sensor and the smart irrigation system sensor, which may account for the discrepancy in water usage.

In one embodiment, the notification may provide an access link to a water usage dashboard. The system 500 may provide the water usage dashboard, which may include one or more pieces of information related to the system 500, property, water usage. The dashboard may include audio, video, charts, graphs, visualizations, AR, VR, metaverse components, tips, recommendations, or any other suitable multimedia components. In one aspect, the dashboard may provide water usage analytics, such as current and historical water usage of a property, water usage of certain appliances, water usage compared to the neighborhood and/or properties having similar attributes, among other things. In one aspect, the water usage dashboard may indicate whether the system is functioning property, e.g., if an IoT water sensor or smart appliance no longer appears to be reporting water usage data, if the system 500 is no longer able to scrape data from a homeowners account with the water service provider 520, or other suitable system information.

According to the example of FIG. 5, the home 502 includes the water meter 565 connected to the main waterline entering the home 502 and measuring the aggregate water usage of the home 502. The water meter 565 reports water usage for the home 502 to the water supplier 520 wirelessly via the network 510. The system 500 may obtain the water usage data of the water meter 565 form the water supplier 520 website. Appliances in the home may have IoT water sensors, such as an IoT water sensor 560A for the washing machine and IoT water sensor 560B for the water heater. The IoT water sensors 560A, 560B may report water usage for their respective appliances to the server 505 via network 510. The water usage data may be displayed on the water usage dashboard, used to generate water usage analytics, detect anomalies such as leaks, and/or excessive water usage.

The property owner may be using the smartphone 515 to obtain the water usage estimate from the system 500 for the home 502 at 233 S. Wacker Dr. in Chicago, IL. The smartphone 515 may be running a mobile app associated with the system 500. The mobile app may request the address of the home 502 from the property owner. The property owner may provide the address to the app via a user interface of the smartphone 515, such as a virtual/soft keyboard, a chatbot associated with the app using NLP to interpret the property owner's spoken responses, and/or any other suitable manner of providing the property address. The smartphone 515 may transmit the property address data to the server 505 via network 510.

The server 505 may determine one or more attributes of the home 502 via property data. The server 505 may obtain the property data directly, indirectly and/or based upon the address. In one example, the server 505 may determine the location (Chicago) of the home 502, which the server 505 may use to estimate the water usage when considering water usage of similar homes in locations proximate Chicago. The server may determine the climate associated with Chicago, which may include the current season and/or recent weather of the home 502. The climate may be a factor indicative of estimating water usage, e.g., more water may be used in winter for a conductive heating system and/or in summer for irrigation, watering plants, a pool, washing a car, etc. The server 505 may obtain a real estate listing associated with the home's address which may indicate the square footage of the property, number of bathrooms, appliances, type of heating system, among other attributes which may influence water usage at the home 502. The server 505 may access census data for the home 502 using the address, which may indicate the number of household members at the home 502 which may also influence water usage and the server's estimate of water usage. In the embodiment according to FIG. 5, as a result of obtaining the property data for the home 502, the server 505 may provide to the property owner's smartphone 515 information indicating the property attributes, which the smartphone 515 displays for the property owner. The property owner may confirm the property information is correct, although in other embodiments verification of the property information may not be a requirement.

The server 505 may also obtain water usage data for the home 502. The water usage data may be provided by the property owner, e.g., via the app running on the smartphone 502, obtained from the water supplier 520, obtained from one or more water sensors/meters, such as the water meter 565 and/or the IoT water sensors 560A, 560B, or any other suitable source or water usage data. In the example according to FIG. 5, the server 505 may have user credentials to access to the property owner's water usage data for their home 502 via the water supplier 520 website. The server 505 may also obtain water usage data directly from the IoT sensors 560A, 560B.

In response to comparing the estimated water usage data and actual water usage data for the home 502, the system 500 may generate a notification 530 and provide the notification 530 to the property owner's smartphone 515. The notification 530 may indicate the water usage estimate for the home 502, the actual water usage for the home 502, and also actionable information. The notification 530 may indicate the property uses an additional +1,129 gallons of water during the month of December in excess of what the system 500 estimates. The notification 530 may also indicate that the IoT water sensor 560B for the water heater may be a cause of increased water usage and provide actionable information via two suggestions which may result in less hot water usage, i.e., to take shorter showers and lower the temperature on the thermostat.

The system 500 may include additional, fewer, and/or alternate components, and may be configured to perform additional, fewer, or alternate actions, including components/actions described herein. Although the system 500 is shown in FIG. 5 as including one instance of various components such as server 505, network 510, water meter 565, smartphone 515, etc., various aspects include the system 500 implementing any suitable number of any of the components shown in FIG. 5 and/or omitting any suitable ones of the components shown in FIG. 5. Moreover, various aspects include the system 500 including any suitable additional component(s) not shown in FIG. 5, such as but not limited to the exemplary components described above. Furthermore, it should be appreciated that additional and/or alternative connections between components shown in FIG. 5 may be implemented.

### Visualizing Water Usage Information

In one embodiment, the system may generate a water usage dashboard for the user to visualize information which may relate to a property and/or associated water usage. In one aspect, the water usage dashboard may indicate the estimated water usage for the property. This may include one or more factors which may contribute to the water usage estimate, such as attributes of the property which may influence water usage, water usage of similar properties on which the estimates may be based, and/or any other suitable data.

In one aspect, the water usage dashboard may include water usage information for the property. This may include water usage information the system obtains from one or more sources, such as a water meter such as water meter 565, IoT water sensors such as IoT water sensors 560A, 560B, a water supplier such as water supplier 520, and/or any other suitable source of water usage information. In one aspect, the water usage information of the property which may be depicted on the water usage dashboard may include past water usage e.g., usage in previous months, years, and/or any other period of time. In one aspect, the water usage information of the property which may be depicted on the water usage dashboard may include water usage trends e.g., historical usage trends at the property, for the property compared to other properties, or any other suitable trends. This may include monthly or quarterly water usage from a current period which may be compared against past water usage from a corresponding period of a previous year (e.g., monthly water usage for June of the past three years may be presented for comparison), or any other suitable period of time and/or trend. In one aspect, the water usage information of the property which may be depicted on the water usage dashboard may include sources of anomalous water usage (e.g., water lines, appliances, or other suitable information pertinent to anomalous water usage. The water usage dashboard may include any other suitable water usage data for a property.

In one aspect, the water usage dashboard may allow the user to provide information related to water usage of the property. User-provided information may include validating water usage at the property which may be anomalous and/or incongruent with water usage estimates and/or historical water usage at the property. The information the user provides may be analyzed and/or processed by a system such a system 500 a server such as sever 505, an ML chatbot such as ML chatbot 152, or in any other suitable manner.

In one example, if the homeowner has a visitor staying at their property for a month and water usage increases during the time of the visitor's stay, the user may be able to verify the water usage increase and indicate the additional occupant at the property. The system may process the verification information, e.g., for training and/or fine-tuning the ML model which generates the water usage estimate.

In one example, if the water usage dashboard user is expected to be on vacation and away from the property such that less water usage is expected during that time, the user may be able to indicate this on the water usage dashboard, e.g., by providing dates which water usage is expected to be below average, how many household members may be on vacation, etc. This information may be used by the trained ML model to adjust the estimated water usage for the property during the time the user is away on vacation, which may provide a more accurate estimate, or for any other suitable purpose.

In one aspect, one or more sensors of a property may provide to the system, such as system 500, data pertinent to water usage to the system which may be reflected on the water usage dashboard. In one example, a smart washing machine may be able to provide information to the water usage dashboard via the server indicating when the washing machine is running and/or how much water may be used when washing a load of laundry. Such information may allow the system to correlate water usage to specific activities and/or appliances. The system may use the correlated information to train and/or fine-tune the ML model, and/or display associated information on the water usage dashboard. In one example, a home security system may detect no movement at a property for an extended period of time and provide associated data to the system. The system may determine that the house is vacant, which may decrease expected water usage at the property, either of which may be reflected in the water usage estimate and/or on the water usage dashboard.

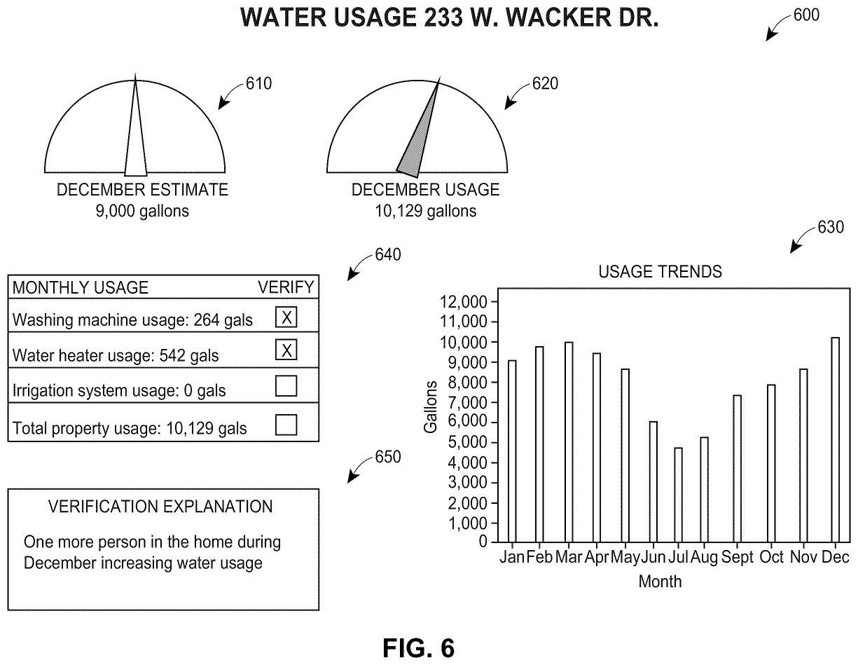

FIG. 6 depicts an exemplary water usage dashboard 600, according to an embodiment. The water usage dashboard 600 may indicate water usage information for the home 502 and may include the monthly water estimate 610, the actual monthly water usage 620; water usage trends 630; detailed monthly usage 640; and user verification information 650 of water usage.

In one aspect, the water usage dashboard 600 provides the water usage estimate 610. e.g., which the trained ML model 410 may generate. The dashboard 600 may visually indicate the estimate of 9,000 gallons for the month of December for the home 502 using a depiction of a meter, dial, gauge, or other suitable visual indicator. The dashboard 600 visually indicates the actual water usage 620 for the home 502 is 10,129 gallons for the month of December. The usage trends 630 graphically indicate various water usage trends from January to December for the home 502. The detailed monthly usage 640 indicates the total water usage of the home 502.

In one aspect, a user of the water usage dashboard 600 may be able to verify information provided by the dashboard 600, as described herein. The user has indicated via checked boxes 642 that for the washing machine water usage and water heater water usage, they will provide verification information 650. In one aspect, an ML chatbot, such as ML chatbot 152, may receive, interpret and/or analyze the verification information 650. This may include a dialog to gather more information between the ML chatbot and dashboard 600 user.

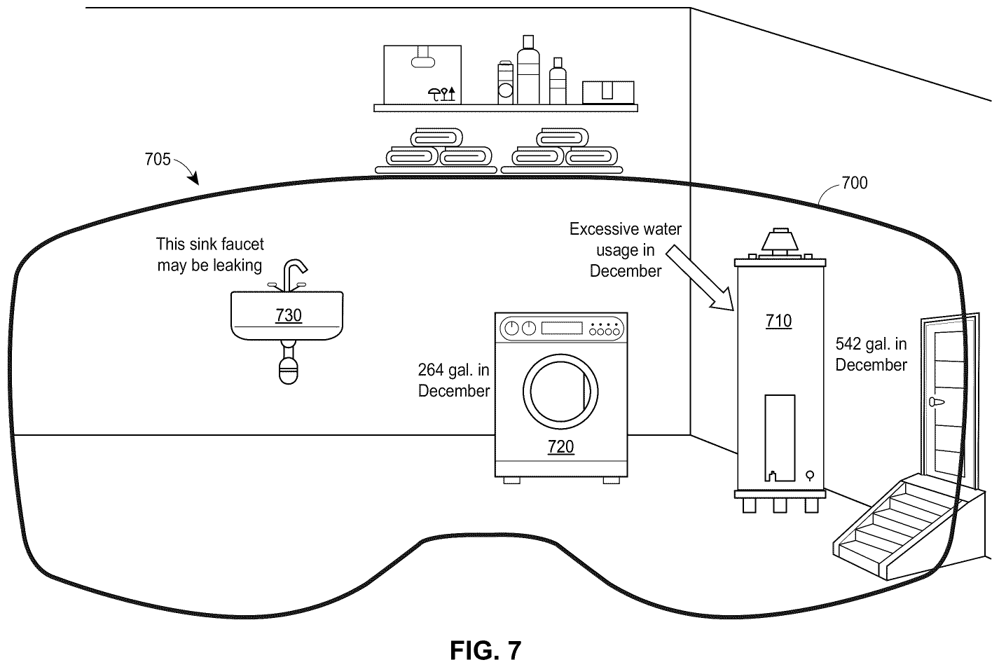

FIG. 7 depicts an exemplary AR headset 700 displaying AR display 705 for visualizing water usage of a property, according to an embodiment. In one embodiment, a system, such as system 500, may provide a notification to a user device such as AR headset 700. The notification may include water usage information which the AR headset 700 may overlay via the AR display 705 onto the environment of the user, which may allow the user to visualize water usage around their property. In one aspect, the water usage information the system may provide to the AR headset 700 may include information also available on the water usage dashboard, such as water usage dashboard 600.

In one embodiment, an underlay layer device of the AR headset 700, such as underlay layer device 318, may create underlay layer data from the field of view (FOV) of the user of the AR headset 700. In one aspect, the AR headset 700 may be able to recognize the appliances and/or objects in the FOV of the user, such as the water heater 710 and washer 720. The AR headset 700 may recognize the objects using machine vision, computer vision, AI, ML or any other suitable technique. In one aspect, the system may have access to property data which may indicate attributes of the property. In one aspect, the property data may indicate the floorplan of the home, the types of appliances of the property, source of water usage at the property, among other things. The underlay layer data may include the property data.

In one embodiment, the AR headset 700 may receive and/or have access to overlay layer data. The system may obtain water usage data information residing on a server, which may include water usage information for appliances and/or objects at the property, and/or other suitable data. The overlay layer data may include the water usage data.

In one aspect, the AR headset 700 and/or server may correlate the underlay layer data with the overlay later data to create the AR display 705. The AR headset 700 and/or a server in communication with the AR headset 700, may process the underlay layer data and the overlay layer data to recognize objects, their location, the location of the AR headset 700, and/or generate the AR display 705. The AR display 705 may be aligned appropriately with the detected objects based upon sensor data from the AR headset 700, such as gyros, IMUs, accelerometers, GPS, or other suitable means of determining the field of view of the wearer of the AR headset 700.

In one aspect, the AR headset 700 may receive the notification, which may include water usage information. The AR display 705 may overlay the water usage information upon objects associated with the water usage. In one example, the AR display 705 indicates the water usage for the hot water heater 710 in December, including that the water usage was excessive. The AR display 705 may also indicate water usage information for washer 720. The water usage information may allow the user to visualize water usage for the property and/or one or more objects of the property.

In one aspect, the notification may provide actionable information, as discussed herein. For example, the system may be able to track water usage of a sink 730 at the property, such as via an IoT water sensor (not shown). The IoT water sensor may indicate the sink uses minimal, but constant water throughout the day. The system may process the water usage information to determine the sink may have a leaking faucet which would be associated with the pattern of water usage the IoT water sensor reports for the sink 730. Accordingly, the AR display 705 may provide information adjacent the sink indicting to the user that the faucet may be leaking.

### Exemplary Computer-Implemented Method for Detecting Anomalous Water Usage at a Property

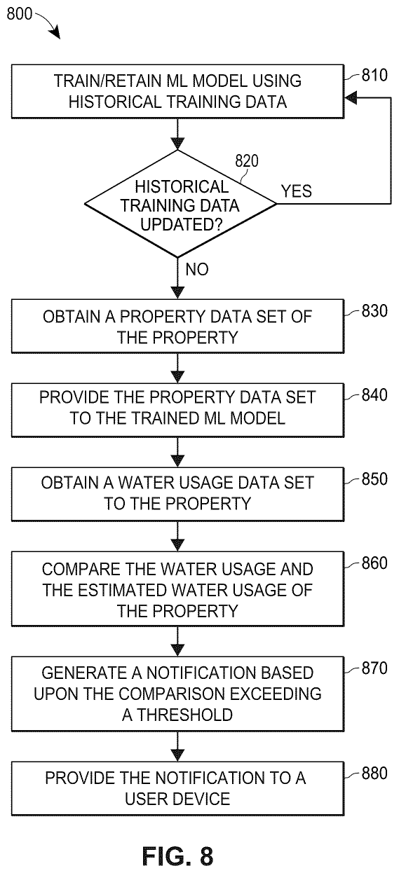

FIG. 8 depicts a flow diagram of an exemplary computer-implemented method 800 for detecting anomalous water usage at a property having a water supply using ML, according to one embodiment. One or more steps of the method 800 may be implemented as a set of instructions stored on a computer-readable memory and executable on one or more processors. The method 800 of FIG. 8 may be implemented via a system, such as system 500.

In one embodiment, the computer-implemented method 800 may include at block 810 training, by one or more processors, an ML model. In one aspect, the ML model may be trained to generate a water usage estimate for a property, according to any of the techniques described elsewhere herein. The trained ML model may include an algorithm including one or more of k-nearest neighbor, support vector regression, and/or random forest. The trained ML model may be stored on one or more memories, such as memory 122 or database 126 of server 105.

The ML model may be trained using a historical training data set. The historical dataset may be stored on one or more memories, such as memory 122 or database 126 of server 105. The historical data set may include, for a plurality of properties, a historical water usage data set indicating historical water usage of the plurality of properties. In one aspect, the historical water usage data set may be crowd-sourced by obtaining a plurality of historical water usage data entries corresponding to the plurality of properties from a plurality of data providers respectively associated with a corresponding property of the plurality of properties.

The historical data set may include, for a plurality of properties, a historical property data set. The historical property data set may include attributes of the plurality of properties influencing the water usage of the plurality of properties. In one aspect, the attributes of the property influencing the water usage of the property may include one or more of a size of the property, a household size of the property, appliances of the property, climate of the property, and/or water features of the property, among other things as described herein.

The trained ML model may be configured to learn relationships between the historical water usage data set and the historical property data set. In one example, the historical training data may indicate associations between the size of a property, the number of bathrooms, the number of people in the household, the location of the property and/or the climate of the property with a quantity of water used at the property.

In one embodiment, the computer-implemented method 800 may include at block 820 for updating, by the one or more processors, the historical training data set to include new data indicative of relationships between the historical water usage data set and the historical property data set. When the historical training data is updated, the computer-implemented method 800 may include at block 810 retraining/fine-tuning, by the one or more processors, the ML model based upon the updated historical training data set and/or storing, by the one or more processors, the retrained ML model on one or more memories, such as memory 122 or database 126 of server 105.

In one embodiment, the computer-implemented method 800 may include at block 830 obtaining, by one or more processors, a property data set of the property. The computer-implemented method 800 may obtain the property data set 830 using any of the techniques described herein. In one aspect, the property data set may include attributes of the property influencing the water usage of the property, as previously discussed herein.

In one embodiment, the computer-implemented method 800 at block 840 may include providing, by the one or more processors, the property data set to a trained ML model. The trained ML model may generate an estimated water usage of the property associated with the property data set.

In one embodiment, the computer-implemented method 800 at block 850 may include obtaining, by the one or more processors, a water usage data set of the property. The computer-implemented method 800 may obtain the water usage data set 850 using any of the techniques described herein. The water usage data set may indicate the water usage of the property. In one aspect, obtaining the water usage data set of the property 830 may include detecting, via one or more IoT sensors (e.g., IoT sensor 160), water usage data associated with an IoT sensor of the property and/or receiving, by the one or more processors via the one or more IoT sensors, the IoT sensor water usage data.

In one aspect, obtaining the water usage data set of the property 830 may include obtaining, by the one or more processors, water usage data associated with a water meter of the property, such as water meter 165.

At block 860, the computer-implemented method 800 may include comparing, by the one or more processors, the water usage and the estimated water usage of the property. Responsive to comparing the water usage and the estimated water usage of the property at block 860, the computer-implemented method 800 may include at block 870 generating, by the one or more processors, a notification based upon the water usage and the estimated water usage comparison exceeding a threshold. In one aspect, the notification may include actionable information comprising one or more recommendations of actions to be taken to reduce the water usage of the property based upon the water usage and the estimated water usage comparison. In one aspect, the computer-implemented method 800, the notification may include an explanation of the water usage. In one embodiment, the computer-implemented method 800 at block 880 may include providing, by the one or more processors, the notification to a user device, such as user device 115. Providing the notification to the user device may include sending a push notification or an alert. In one aspect, additional information may be provided by providing a link in the notification to enable the user to access the further information.

In one embodiment, generating the notification 870 may include generating, by the one or more processors, a water usage dashboard including water usage information of the property. The computer-implemented method 800 may provide, by the one or more processors, an access link to the water usage dashboard to the user device, e.g., via the notification. The computer-implemented method 800 may include receiving, by the one or more processors, water usage validation at the water usage dashboard via the user device.

It should be understood that not all blocks of the exemplary flow diagram 800 are required to be performed. Moreover, the exemplary flowchart 800 is not mutually exclusive (e.g., block(s) from exemplary flow diagram 800 may be performed in any particular implementation).

### ADDITIONAL CONSIDERATIONS

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based upon the application of 35 U.S.C. § 112 (f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. In one example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. In one example, where the hardware modules comprise a general-purpose processor configured using software, the general-purpose processor may be configured as respective different hardware modules at different times. Software may accordingly configure a processor, in one example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, in one example, through the storage and retrieval of information in memory structures to which the multiple hardware modules have access. In one example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. In one example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. In one example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. In one example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. In one example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

What is claimed:

1. A computer-implemented method for detecting anomalous water usage at a property having a water supply system using machine learning (ML), the computer-implemented method comprising:
obtaining, by one or more processors, a property data set of the property, wherein the property data set includes attributes of the property influencing the water usage of the property;
providing, by the one or more processors, the property data set to an ML model trained to generate an estimated water usage of the property associated with the property data set, wherein:
the ML model is trained using a historical training data set;
the historical training data set includes, for a plurality of properties:
a historical water usage data set indicating historical water usage of the plurality of properties; and
a historical property data set including attributes of the plurality of properties influencing the water usage of the plurality of properties; and
the trained ML model is configured to learn relationships between the historical water usage data set and the historical property data set;
obtaining, by the one or more processors, a water usage data set of the property indicating water usage of the property;
comparing, by the one or more processors, the water usage and the estimated water usage of the property;
responsive to comparing the water usage and the estimated water usage of the property, generating, by the one or more processors, a notification based upon the water usage and the estimated water usage comparison exceeding a threshold; and
providing, by the one or more processors, the notification to a user device.

2. The computer-implemented method of claim 1, wherein the historical water usage data set is crowd-sourced by obtaining a plurality of historical water usage data entries corresponding to the plurality of properties from a plurality of data providers respectively associated with a corresponding property of the plurality of properties.

3. The computer-implemented method of claim 1, wherein the attributes of the property influencing the water usage of the property include one or more of a size of the property, a household size of the property, appliances of the property, climate of the property, and/or water features of the property.

4. The computer-implemented method of claim 1, further comprising:
updating, by the one or more processors, the historical training data set to include new data indicative of relationships between the historical water usage data set and the historical property data set;
retraining, by the one or more processors, the ML model based upon the updated historical training data set; and
storing, by the one or more processors, the retrained ML model on one or more memories.

5. The computer-implemented method of claim 1, wherein the ML model includes an algorithm including one or more of k-nearest neighbor, support vector regression, and/or random forest.

6. The computer-implemented method of claim 1, wherein the notification includes actionable information comprising one or more recommendations of actions to be taken to reduce the water usage of the property based upon the water usage and the estimated water usage comparison.

7. The computer-implemented method of claim 1, wherein the notification includes one or more of an explanation of the water usage, or an access link to a water usage dashboard.

8. The computer-implemented method of claim 1, wherein obtaining the water usage data set of the property further comprises:
detecting, via one or more IoT sensors, water usage data associated with an IoT sensor of the property; and
receiving, by the one or more processors via the one or more IoT sensors, the IoT sensor water usage data.

9. The computer-implemented method of claim 1, wherein obtaining the water usage data set of the property further comprises:
obtaining, by the one or more processors, water usage data associated with a water meter of the property.

10. The computer-implemented method of claim 1, further comprising:
generating, by the one or more processors, a water usage dashboard including water usage information of the property;
providing, by the one or more processors, an access link to the water usage dashboard to the user device; and
receiving, by the one or more processors, water usage validation at the water usage dashboard via the user device.

11. A computer system for detecting anomalous water usage at a property having a water supply system using machine learning (ML), the computer system comprising:
one or more processors; and
one or more non-transitory memories storing processor-executable instructions that, when executed by the one or more processors, cause the system to:
obtain a property data set of the property, wherein the property data set includes attributes of the property influencing the water usage of the property;
provide the property data set to an ML model trained to generate an estimated water usage of the property associated with the property data set, wherein:
the ML model is trained using a historical training data set;
the historical training data set includes, for a plurality of properties:
a historical water usage data set indicating historical water usage of the plurality of properties; and
a historical property data set including attributes of the plurality of properties influencing the water usage of the plurality of properties; and
the trained ML model is configured to learn relationships between the historical water usage data set and the historical property data set;
obtain a water usage data set of the property indicating water usage of the property;
compare the water usage and the estimated water usage of the property;
responsive to comparing the water usage and the estimated water usage of the property, generate a notification based upon the water usage and the estimated water usage comparison exceeding a threshold; and
provide the notification to a user device.

12. The computer system of claim 11, wherein the historical water usage data set is crowd-sourced by obtaining a plurality of historical water usage data entries corresponding to the plurality of properties from a plurality of data providers respectively associated with a corresponding property of the plurality of properties.

13. The computer system of claim 11, wherein the attributes of the property influencing the water usage of the property include one or more of a size of the property, a household size of the property, appliances of the property, climate of the property, and/or water features of the property.

14. The computer system of claim 11, further comprising instructions that, when executed by the one or more processors, cause the system to:
update the historical training data set to include new data indicative of relationships between the historical water usage data set and the historical property data set;
retrain the ML model based upon the updated historical training data set; and
store the retrained ML model on one or more memories.

15. The computer system of claim 11, wherein the notification includes actionable information comprising one or more recommendations of actions to be taken to reduce the water usage of the property based upon the water usage and the estimated water usage comparison.

16. The computer system of claim 11, wherein the notification includes one or more of an explanation of the water usage, or an access link to a water usage dashboard.

17. The computer system of claim 11, wherein to obtain the water usage data set of the property further comprises:
one or more IoT sensors; and
instructions that, when executed by the one or more processors, cause the system to:
detect water usage data associated with an IoT sensor of the property; and
receive the IoT sensor water usage data.

18. The computer system of claim 11, wherein to obtain the water usage data set of the property further comprises instructions that, when executed by the one or more processors, cause the system to:
obtain water usage data associated with a water meter of the property.

19. The computer system of claim 11, further comprising instructions that, when
executed by the one or more processors, cause the system to:
generate a water usage dashboard including water usage information of the property;
provide an access link to the water usage dashboard to the user device; and
receive water usage validation at the water usage dashboard via the user device.

20. A non-transitory computer-readable medium storing processor-executable instructions that, when executed by one or more processors, cause the one or more processors to:
obtain a property data set of the property, wherein the property data set includes attributes of the property influencing the water usage of the property;
provide the property data set to an ML model trained to generate an estimated water usage of the property associated with the property data set, wherein:
the ML model is trained using a historical training data set;
the historical training data set includes, for a plurality of properties:
a historical water usage data set indicating historical water usage of the plurality of properties; and
a historical property data set including attributes of the plurality of properties influencing the water usage of the plurality of properties; and
the trained ML model is configured to learn relationships between the historical water usage data set and the historical property data set;
obtain a water usage data set of the property indicating water usage of the property;
compare the water usage and the estimated water usage of the property;
responsive to comparing the water usage and the estimated water usage of the property, generate a notification based upon the water usage and the estimated water usage comparison exceeding a threshold; and
provide the notification to a user device.
